(19) United States
(12) Patent Application Publication
(10) Pub. No.: US 2013/0275791 A1
(43) Pub. Date: Oct. 17, 2013

(54) Method and System for Tracking and Selecting Optimal Power Conserving Modes of a PCD

(71) Applicants: Tracy A. Ulmer, Boulder, CO (US); Norman S. Gargash, Boulder, CO (US)

(72) Inventors: Tracy A. Ulmer, Boulder, CO (US); Norman S. Gargash, Boulder, CO (US)

(73) Assignee: QUALCOMM INCORPORATED, San Diego, CA (US)

(21) Appl. No.: 13/542,025

(22) Filed: Jul. 5, 2012

Related U.S. Application Data
(60) Provisional application No. 61/623,150, filed on Apr. 12, 2012.

(51) Int. Cl. G06F 1/32

(52) U.S. Cl. CPC G06F 1/3234
USPC 713/323

(57) ABSTRACT

A method and system for tracking and selecting optimal power conserving modes of a PCD includes detecting enablement or disablement of a reduced power mode and detecting one of a new and a change in a latency restriction. Next, a low power mode which has a minimum entry and exit latency may be identified. Then, it may be determined if a lowest latency restriction is less than the minimum entry and exit latency. A function pointer may be adjusted based on the output of the determining step. The function pointer may reference a halt state and a reduced power state for the PCD. Then, conditions favorable for at least one of an idle state and a reduced power mode of the PCD may be assessed. If conditions are favorable for an idle state or a reduced power mode for the PCD, then status of the function pointer may be read.

### PRIORITY CLAIM AND RELATED APPLICATIONS STATEMENT

Priority under 35 U.S.C. §119(e) is claimed to U.S. provisional application entitled “METHOD AND SYSTEM FOR TRACKING AND SELECTING OPTIMAL POWER CONSERVING MODES OF A PCD,” filed on Apr. 12, 2012 and assigned U.S. provisional application Ser. No. 61/623,150. The entire contents of this provisional patent application is hereby incorporated by reference.

### DESCRIPTION OF THE RELATED ART

Central processing units (“CPUs”) of portable computing devices (“PCDs”), like mobile phones and tablet portable computers (“PCs”), typically enter into a sleep state in order to conserve power. Power conservation is a major concern for PCDs since many PCDs receive power from one or more batteries. One problem that exists with conventional PCDs and their CPUs is that prior to entering into sleep state, a CPU usually must perform several different housekeeping tasks before a sleep state, also known as a lower power mode, can be entered/initiated.

These housekeeping tasks, often characterized as overhead, performed by the CPU may consume more precious power than the CPU is intending to conserve. For example, in situations where the CPU is trying to enter into a low power mode in which the CPU is merely halted instead of entering into a deep low power mode, it has been found that the CPU may consume more power to achieve this low power mode than may be necessary.

Specifically, problems have been encountered in PCDs during audio playback. While the CPU is waiting in an idle state for certain interrupts during audio playback, the CPU may consume more power than is necessary because the CPU may attempt to enter into a sleep state during this wait time. Another problem includes increasing the amount of time to download data when a CPU is in an idle state and is trying to either enter into a sleep state or halt its own processes. In some situations, if the CPU has entered into the sleep state, it takes a certain amount of time to exit that sleep state and for the CPU to become active and perform its requisite task(s) for receiving downloaded data.

The CPU typically enters into a single threaded mode so that it may, without interruption, assess what level of low power mode should be entered by the CPU. While in the single threaded mode, a CPU may check on the constraints of the entire PCD. Constraints may include any latency restrictions, detecting what low power modes are enabled, as well as detecting if any other low-power modes have been entered into by other hardware. If there were no constraints required by other elements of the PCD, the CPU would exit the single threaded mode and immediately halt the processor. However, this lengthy process of checking for system constraints and optimal conditions for entering a halt state and/or a deep lower power mode may consume more power than necessary which is a major concern of a PCD powered by batteries.

### SUMMARY

A method and system for tracking and selecting optimal power conserving modes of a portable computing device (“PCD”) includes detecting enablement or disablement of a reduced power mode and detecting one of a new and a change in a latency restriction. Next, a low power mode which has a minimum entry and exit latency may be identified. Then, it may be determined if a lowest latency restriction is less than the minimum entry and exit latency. After this determination, a function pointer may be adjusted based on the output of the determining step.

The function pointer may reference a halt state and a reduced power state for the PCD. The detection of the enablement or disablement of reduced power mode and the detection of one of a new and a change in a latency restriction may be performed in parallel. Then, a determination if conditions are favorable for at least one of an idle state and a reduced power mode of the PCD may be performed. If conditions are favorable for at least one of an idle state and a reduced power mode for the PCD, then a current state of the function pointer may be read and performed by a processor.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating exemplary elements of a system for distributed resource management in a portable computing device (“PCD”);

FIG. 2 is a functional block diagram illustrating an example of an instance in which a first processor needs to request a resource controlled by a second processor;

FIG. 3 is a diagram of a first aspect of a node architecture that manages resources of a PCD;

FIG. 4 is a directed acyclic resource graph for a group of exemplary resources of a PCD;

FIG. 5 is a general diagram of a second aspect of the node architecture that manages resources of a PCD;

FIG. 6 is specific diagram of a second aspect of the node architecture that manages resources of a PCD;

FIG. 7 is a flowchart illustrating a method for creating a node architecture for managing resources of a PCD;

FIG. 8 is a continuation flowchart of FIG. 7 illustrating a method for creating a node architecture for managing resources of a PCD;

FIG. 9 is a flowchart illustrating a sub-method or a routine of FIGS. 7-8 for receiving node structure data in a software architecture for a PCD;

FIG. 10 is a flowchart illustrating a sub-method or a routine of FIGS. 7-8 for creating a node in a software architecture for a PCD;

FIG. 11 is a flowchart illustrating a sub-method or a routine of FIG. 10 for creating a client in a software architecture of a PCD;

FIG. 12 is a flowchart illustrating a method for creating a client request against a resource in a software architecture for a PCD;

FIG. 13 illustrates a communication path between two processors, each controlling resources of its own resource graph;

FIG. 14 illustrates a portion of a sleep subsystem for tracking one or more conditions and for selecting an optimal power conserving mode of a processor based on those conditions;

FIG. 15 is a logical flowchart illustrating a method for tracking one or more conditions useful for selecting optimal power conserving modes of a processor and switching a function pointer to a halt state when it is detected that no modes are enabled; and

FIG. 16 is a logical flowchart illustrating a method for selecting an optimal power conserving mode of a processor based on the conditions tracked in the method illustrated in FIG. 15.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology, have enabled numerous PCDs with multiple capabilities. Therefore, a PCD may be a cellular telephone, a satellite telephone, a pager, a personal digital assistant (“PDA”), a smartphone, a navigation device, a smartbook or reader, a media player, a combination of the aforementioned devices, a tablet personal computer (“PC”), and a laptop computer with a wireless connection, among others.

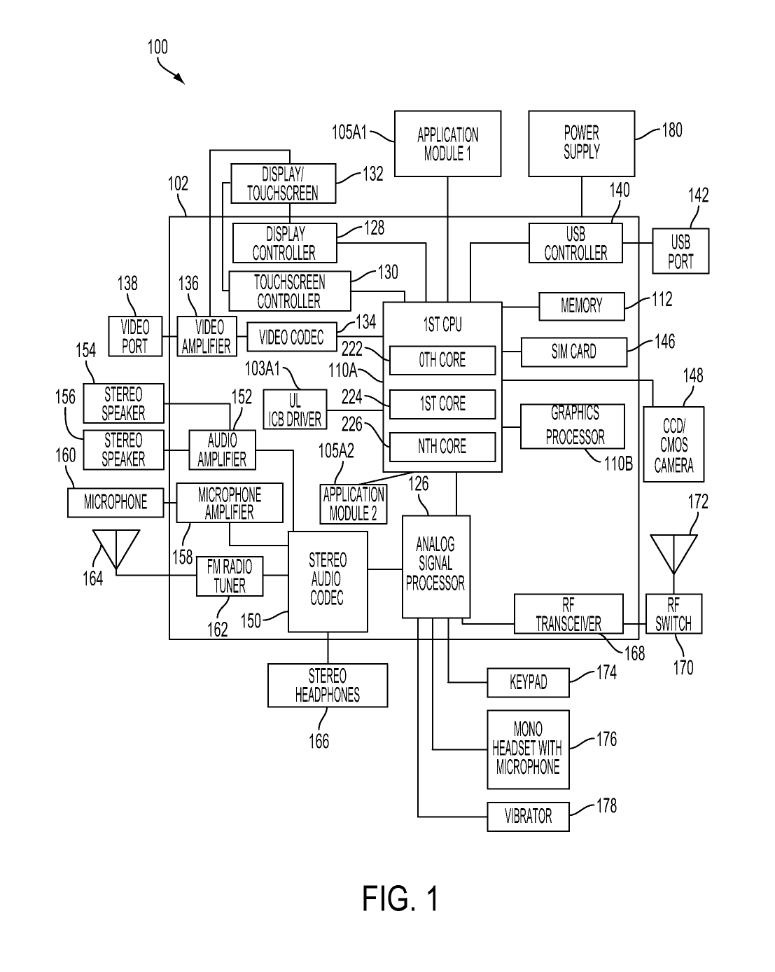

FIG. 1 is a functional block diagram of an exemplary, non-limiting aspect of a PCD 100 in the form of a wireless telephone for implementing methods and systems for distributed resource management in a portable computing device. As shown, the PCD 100 includes an on-chip system 102 that has a multi-core, central processing unit (“CPU”) 110A, a graphics processor 110B, and an analog signal processor 126. These processors 110A, 110B, 126 may be coupled together on one or more system busses or another interconnect architecture, as known to one of ordinary skill in the art.

The CPU 110A may comprise a zeroth core 222, a first core 224, etc., through an Nth core 226, as understood by one of ordinary skill in the art. In alternative embodiments, instead of CPU 110A and a graphics processor 110B, one or more digital signal processors (“DSPs”) may also be employed as understood by one of ordinary skill in the art. Further, in alternative embodiments, two or more multi-core processors may be included.

As illustrated in FIG. 1, a display controller 128 and a touchscreen controller 130 are coupled to the multi-core CPU 110A. A touchscreen display 132 external to the on-chip system 102 is coupled to the display controller 128 and the touchscreen controller 130. Also included in PCD 100 is a video coder/decoder (“codec”) 134, e.g., a phase-alternating line (“PAL”) encoder, a sequential couleur avec memoire (“SECAM”) encoder, a national television system(s) committee (“NTSC”) encoder or any other type of video encoder 134 coupled to the multi-core central processing unit (“CPU”) 110A. A video amplifier 136 is coupled to the video encoder 134 and the touchscreen display 132.

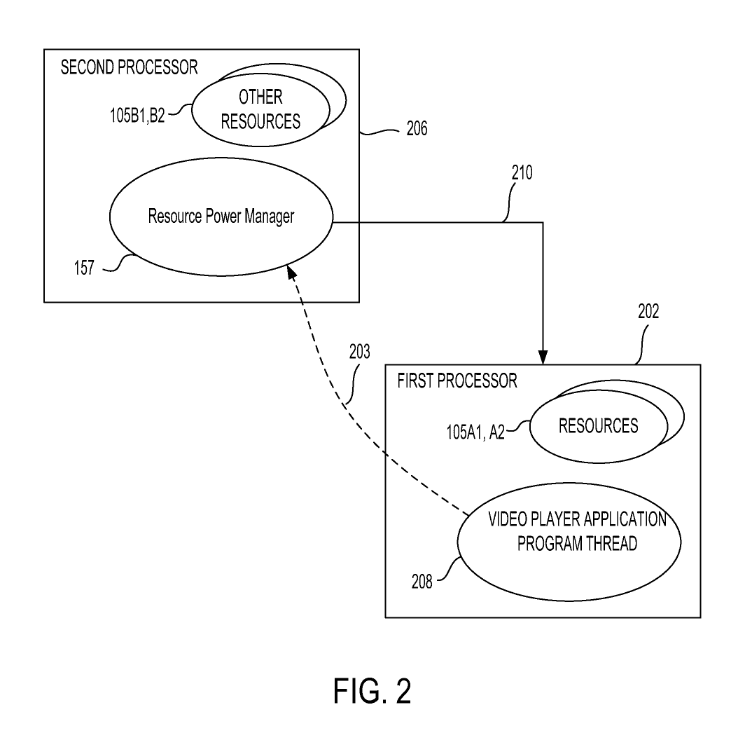

A video port 138 is coupled to the video amplifier 136. As depicted in FIG. 2, a universal serial bus (“USB”) controller 140 is coupled to the CPU 110A. Also, a USB port 142 is coupled to the USB controller 140. A subscriber identity module (SIM) card 146 may also be coupled to the CPU 110A. Further, as shown in FIG. 1, a digital camera 148 may be coupled to the CPU 110A. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 126. An RF switch 170 may be coupled to the RF transceiver 168 and an RF antenna 172. As shown in FIG. 1, a keypad 174 may be coupled to the analog signal processor 126. Also, a mono headset with a microphone 176 may be coupled to the analog signal processor 126. Further, a vibrator device 178 may be coupled to the analog signal processor 126. FIG. 1 also shows that a power supply 180, for example a battery, is coupled to the on-chip system 102. In a particular aspect, the power supply 180 includes a rechargeable battery or a direct current (“DC”) power supply that is derived from an alternating current (“AC”)-to-DC transformer that is connected to an AC power source.

Some of the above-described elements of the PCD 100 may comprise hardware, while others may comprise software, and still others may comprise a combination of hardware and software. The term “resource” is used herein to refer to any such element, whether hardware, software or a combination thereof, that is controllable by a processor. A resource may be defined in one aspect as an encapsulation of the functionality of such an element. Except where it may otherwise be indicated, the term “processor” or “master processor” is used herein to refer to a processor such as the CPU 110, graphics processor 110B, the analog signal processor 126, or to any other processor, controller or similar element that operates under the control of software, firmware, or similar control logic.

As described in further detail below, an example of a resource is a software element that executes on a processor. A thread of execution on a processor, such as, for example, a thread relating to an executing application program, may access a resource by causing a “request” to be issued on the resource. As described below, resource requests are processed through a software-based system referred to in this disclosure as a “framework.”

The term “client” is used broadly in this disclosure to refer to an element that effects the function of requesting a resource. Thus, as the terms are used herein, a thread may create or make use of a client for the purpose of issuing resource requests. It should be noted that, in some instances, a resource may create or use a client, such that a resource may cause a resource request to be issued against another resource. As described in further detail below, such other resource may be referred to herein as a “dependent” resource due to a dependency relationship between the requesting resource and requested resource. Resources and clients may be represented by data structures in memory.

Since resources are controlled by specific processors in a multi-processor PCD 100, not every processor in PCD 100 has access to every resource in PCD 100. FIG. 2 illustrates an example of an instance in which it may be desirable for a first processor 202 in PCD 100 to issue a resource request 203 against a resource power manager 157 controlled by a second processor 206 in PCD 100. Note that the first processor 202 may also control a plurality of resources 105A1, 105A2. Likewise, the second processor 206 may control a plurality of additional resources 105B1, 105B2.

In an instance in which the first processor 202 is executing a thread 208 relating to, for example, a video player application program, the thread 208 may call for adjustment of one or more operating parameters of the first processor 202 that enhance the performance of the first processor 202. (Although thread 208 and the resource power manager 157 are conceptually illustrated as residing in their respective processors 202 and 206 for purposes of clarity, one of ordinary skill in the art understands that such elements are executed or otherwise operated upon by the processor in the processor's memory space in accordance with well understood computing principles.) Such operating parameters may include, for example, clock speed and bus speed.

For example, various processors may use the same bus clock, but only one of the processors may have direct (hardware-level) control of the bus clock. Increasing clock speed may result in better performance by, for example, a video player application program, since the playback of video is generally a more processing power-intensive task than some other tasks. As processing power is commonly expressed in millions of instructions per second (“MIPS”), the thread 208 may issue a call for a certain number of MIPS. The resource power manager 157 may include an algorithm that, in response to a request for a specified number of MIPS, causes changes in signals 210 that may represent clock speed, bus speed or other parameters that promote the first processor 202 operating at the requested MIPS level.

It may be possible for a thread to access the resource power manager 157 through an application program interface (API) specific to a bus or protocol through which the first processor 202 may communicate with the second processor 206. However, the framework described below may provide a more uniform way to handle resource requests than a resource-specific and bus-specific API. As described below, via the framework, resource requests are issued and serviced in a uniform manner without regard to whether the request is against a resource controlled by the same processor from which the resource request is issued or against a resource controlled by a different processor.

A resource controlled by the same processor from which the resource request is issued may be referred to as a “native” resource. A resource controlled by a processor other than that from which the resource request is issued may be referred to herein as a “remote resource” or “distributed resource.”

In addition, issuing a request against a remote resource incurs processing overhead in the form of a time delay or latency. That is, a certain amount of time is required for the message or messages relating to the resource request to be sent between processors. In some instances, a single resource request may result in multiple inter-processor messages.

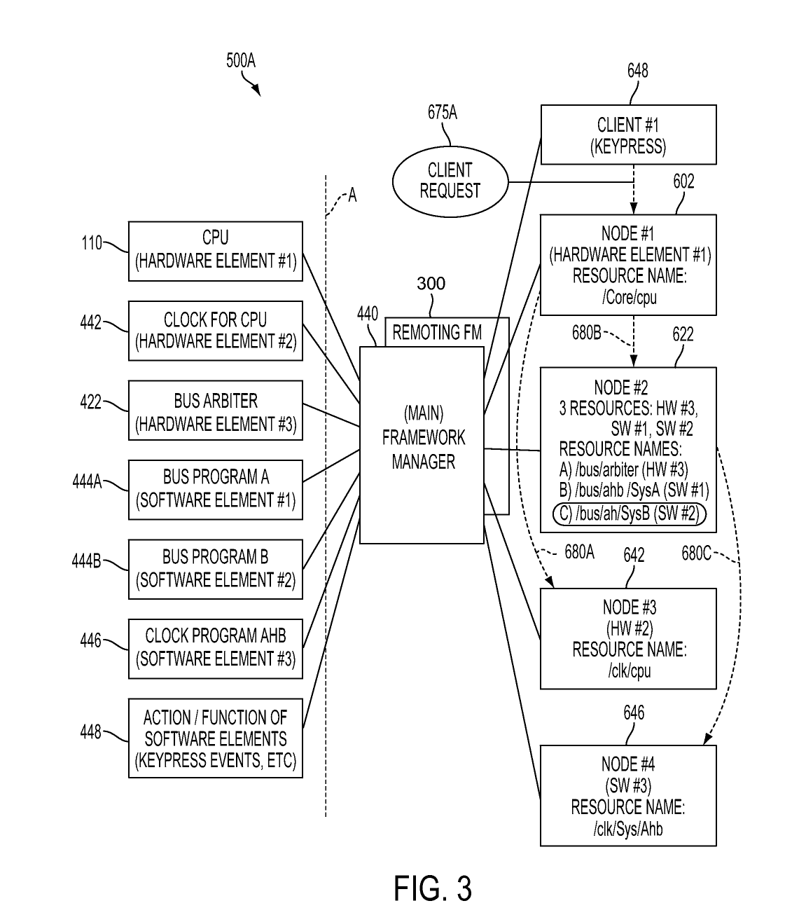

FIG. 3 is a diagram comprising functional blocks which represent software or hardware (or both) of the PCD 100. The blocks to the left of the line “A” represent resources of the PCD 100 that are controlled by the CPU 110A. Such resources may include: the CPU 110A itself, also referred to generally as the first hardware element (hardware element #1); a clock 442 for the CPU 110A, also referred to generally as the second hardware element (hardware element #2); a bus arbiter or scheduler 422, also referred to generally as the third hardware element (hardware element #3); a bus program A—444A, also referred to generally as the first software element (software element #1); a bus program B—444B, also referred to generally as the second software element (software element #2); a clock program AHB, referred to generally as the third software element (software element #3); and an action or function monitored by a software element generally indicated as a keypress 448.

The CPU 110A controls or has access to the above-referenced resources because the resources are within the memory space of the CPU 110A and no other restrictions, such as security restrictions, exist that would inhibit CPU 110A from accessing those resources. For example, CPU 110A may be capable of controlling or accessing hardware registers of those resources. It should be noted that PCD 100 may include other CPUs 110 (see, e.g., FIG. 2) that control or have access to resources other than the above-referenced resources.

A framework manager 440, which may comprise a library of computer instructions, manages nodes that encapsulate functionality of the resources. That is, the nodes may be accessed to indirectly access the resources. For convenience, a node encapsulating the functionality of a resource may be referred to herein as including, comprising, having, etc., the resource. Each node may include one or more resources. The nodes may be defined in software code, firmware, or a similar medium, and instantiated as data structures in, for example, memory 112 (FIG. 1) during operation of the PCD 100.

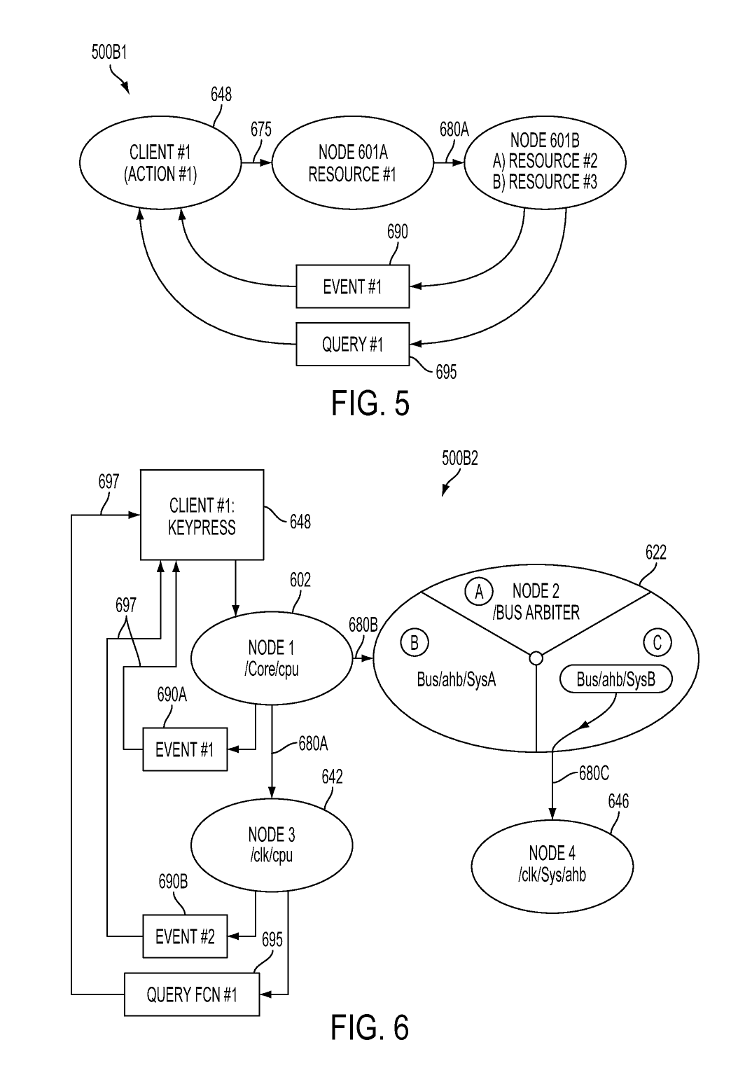

The nodes 601 may be instantiated during a start-up, power-up, initialization, boot-up, etc., sequence, or at any other suitable time during operation of the PCD 100. It should be noted that a reference herein to instantiating, issuing a request on, or otherwise interacting with a resource should be understood as meaning interacting with a node that includes that resource. For the remainder of this disclosure, a generic or non-specific node will be designated with reference numeral 601 as described below with reference to FIG. 5.

Nodes 601 may include, for example, a first node 602 having a single resource that generally corresponds with the first hardware element or central processing unit 110. With the software architecture described in this disclosure, each resource of a node 601 may be provided with a unique name comprising one or more alphanumeric characters. In the exemplary embodiment illustrated in FIG. 3, the resource of the first node 602 has been assigned the resource name of “core/cpu.” This exemplary resource name generally corresponds to conventional file naming structures known to one of ordinary skill in the art. However, as recognized by one of ordinary skill the art, other types of resource names containing any other combination of alpha-numeric characters and/or symbols are well within the scope of this disclosure.

Nodes 601 may further include, for example, a second node 622 having a plurality of resources. In this exemplary embodiment, the second node 622 has a first resource comprising a single hardware element corresponding to the bus arbiter or scheduler 422. The second resource of the second node 622 comprises a software element generally corresponding to the first software element of the bus program A 444A. The third resource of the second node 622 comprises another software element generally corresponding to the second software element of the bus program B 444B. One of ordinary skill in the art recognizes that any combination and any number of resources and resource types for a given node 601 are well within the scope of this disclosure.

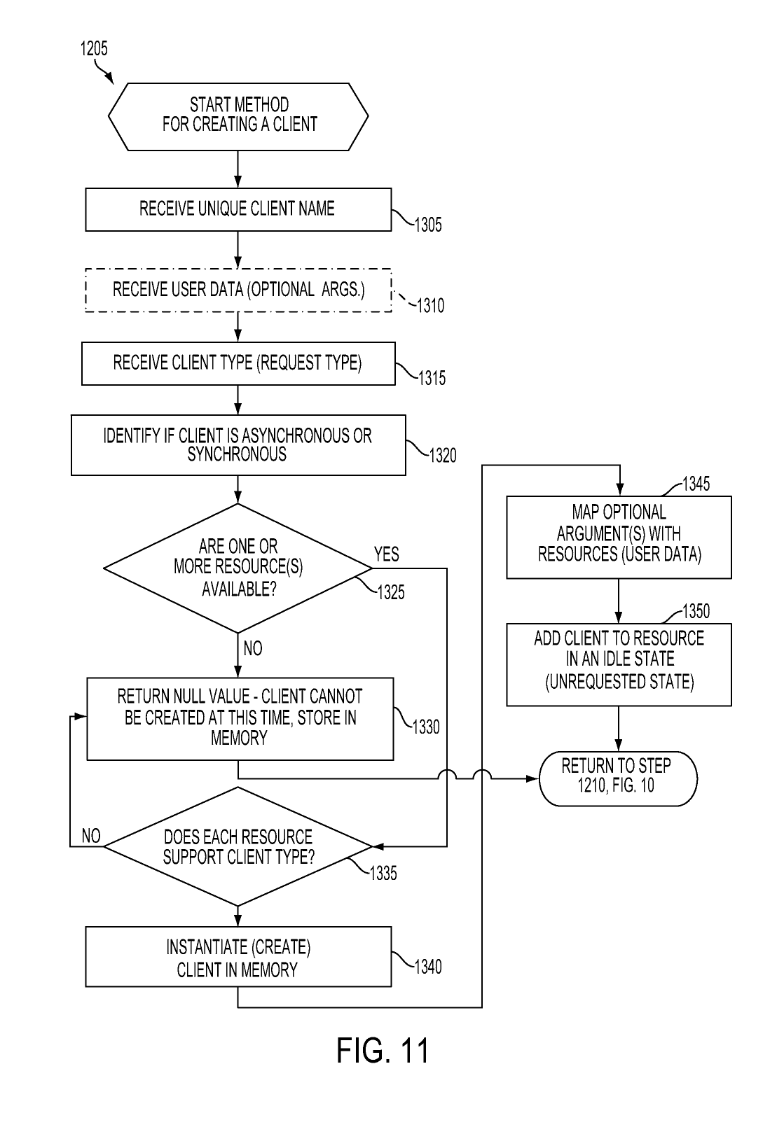

FIG. 3 also illustrates a first client 648 that generally corresponds to an action or function of the two software elements 448, 450. In the exemplary embodiment illustrated in FIG. 3, the first client 648 generally corresponds to a keypress action that may occur within a particular application program module 105 supported by the portable computing device 100. However, one of ordinary skill in the art recognizes that other actions and/or functions of software elements besides keypresses are well within the scope of this disclosure. Further details about client requests 648 and their respective creation will be described below in connection with FIG. 11.

FIG. 3 also illustrates relationships between particular architectural elements. For example, FIG. 3 illustrates a relationship between the client 648 and the first node 602. Specifically, the first client 648 may generate a client request 675A, illustrated with dashed lines, which is managed or handled by the first node 602 that comprises the resource “/core/cpu.” Typically, there are a predetermined or set number of types of client requests 675. Client requests 675 will be described in further detail below in connection with FIG. 11.

Other relationships displayed in FIG. 3 include dependencies illustrated with dashed lines 680. Dependencies are relationships between respective resources of another node 601. A dependency relationship usually indicates that a first resource (A) is reliant upon a second resource (B) that may provide the first resource (A) with information. This information may be a result of an operation performed by a second resource (B) or it may simply comprise status information that is needed by the first resource (A) or any combination thereof The first resource (A) and second resource (B) may be part of the same node 601 or they may be part of different nodes 601. It should be noted that client requests 675 may originate not only from threads of execution, such as in the example of the above-described keypress action, but also from other nodes 601. To obtain information from a dependent node 601, a node 601 may issue a client request 675 to its dependent node 601. Thus, the dashed lines 680 that indicate dependencies may also indicate the direction of potential client requests 675.

In FIG. 3, the first node 602 is dependent upon the second node 622 as indicated by the dependency arrow 680B which originates with the first node 602 and extends to the second at 622. FIG. 3 also illustrates that the first node 602 is also dependent upon the third node 642 as illustrated by the dependency arrow 680A. FIG. 3 also illustrates that the second node 622 is dependent upon the fourth node 646 as illustrated by the dependency arrow 680C. One of ordinary skill in the art recognizes that the dependencies 680 illustrated with the dashed arrows of FIG. 3 are only exemplary in nature and that other combinations of dependencies between respective nodes 601 are within the scope of this disclosure.

The framework manager 440 is responsible for maintaining the relationships described above, that include, but are not limited to, the client requests 675 and the dependencies 680 illustrated in FIG. 3. Some such relationships, such as dependencies, exist at a PCD start-up time (i.e., power-up, initialization, boot-up, etc.) by virtue of the way the resources and their nodes 601 have been defined in the software code in PCD 100 that the framework manager 440 accesses at such a start-up time to begin the node instantiation process. Other such relationships, such as client requests 675, arise after nodes 601 have been instantiated, such as during execution of an application program thread in which an application program invokes a resource. Whether client requests 675 originate from executing application program threads or similar elements other than nodes 601 (e.g., client request 675A) or originate from a node 601, client requests 675 are directed through the framework manager 440. The framework manager 440 directs the transfer of information among the nodes 601. Conceptually, the framework manager 440 serves as a matrix through which multiple threads may essentially concurrently communicate with the nodes 601. Though different threads may involve different data, the same framework manager software code may service multiple threads.

As described below in further detail, the framework manager 440 may instantiate a node 601 as soon as the node's dependent nodes are instantiated, i.e., when the dependencies 680 for any given node 601 have been resolved. The framework manager 440 attempts to instantiate all nodes 601 that have been defined in the software architecture of PCD 100. A dependency 680 is completed or resolved when a resource that supports a dependency is in existence or is in a ready state for handling information that relates to the dependency 680.

For example, the first node 602 comprising the single resource “/core/cpu” may not be instantiated by the framework manager 440 if the third node 642 comprising the single resource “/clk/cpu” has not been instantiated because of the dependency relationship 680A that exists between the first node 602 and the third node 642. Once the third node 642 has been instantiated by the framework manager 440, then the framework manager 440 may instantiate the second node 602 because of the dependency relationship 680A.

If the framework manager 440 is unable to instantiate a particular node 601 because one or more of its dependencies 680 are incomplete or unresolved, the framework manager 440 will continue running or executing steps corresponding to those nodes 601 that were instantiated successfully. The framework manger 440 will usually skip over a call for a particular node 601 that may not exist due to incomplete dependencies in which dependent resources have not been created, and return messages to that call which reflect that incomplete status.

In a multi-core environment, such as illustrated in FIG. 1, the framework manager 440 may create or instantiate nodes 601 on separate cores, such as the 0th, first and Nth cores 222, 224, and 226 of FIG. 1. Nodes 601 may generally be created in a multi-core environment on separate cores and in parallel as long as the nodes 601 are not dependent on one another and if all of a particular node's corresponding dependencies, as described below, are complete. In a multi-processor environment, the nodes 601 may be created or instantiated on various processors, such as the CPU 110A, graphics processor 110B, etc., of FIG. 1. That is, some nodes 601 may exist in the memory space of one processor, while other nodes 601 may exist in the memory space of another processor. It should be noted, however, that nodes 601 on one processor may not be accessible to nodes 601 on the other processor via only framework manager 440.

A remoting framework manager 300 that is similar to the above-described (main) framework manager 440 may exist in parallel with the framework manager 440. The remoting framework manager 300 cooperates with or works with the framework manager 440 to coordinate inter-processor information transfers between nodes 601 on different processors. That is, the remoting framework manager 300 helps framework manager 440 maintain the relationships described above, such as dependencies and client requests, in instances in which the nodes 601 that are involved exist on different processors.

Thus, nodes 601 on one processor may not rendered accessible to nodes 601 on another other processor via the combined effect of framework managers 440 and 300. Moreover, the combination of framework managers 440 and 300 may perform all of the functions ascribed in this disclosure to framework manager 440, whether the nodes 601 that are involved exist on the same processor different processors. In such a multi-processor embodiment, individual copies of the software that framework managers 300 and 440 comprise may reside in the domain of each of the processors. Thus, each processor has access to the same framework manager software.

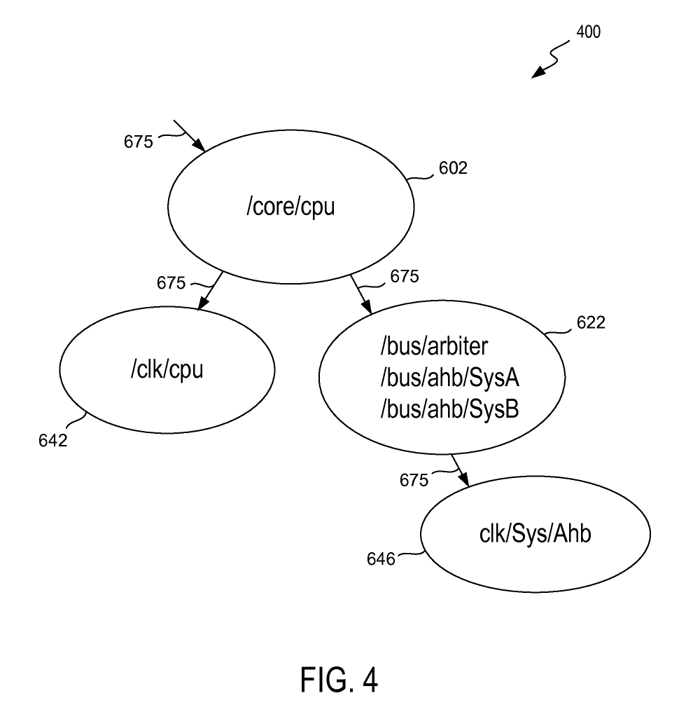

FIG. 4 conveniently reorganizes the above-described nodes 602, 622, 642 and 646 in the form of a directed acyclic graph (“DAG”) 400. The graph 400 is another way of defining the software architecture described above. In the lexicon of graph theory, the vertices of the graph 400 correspond to the nodes 601, the edges of the graph 400 correspond to client requests 675, and adjacent nodes or vertices represent resource dependencies. One of ordinary skill in the art will recognize that the graph 400 is a directed graph as a result of the dependencies and is acyclic because the framework manager 440 prevents a cycle from being defined in which resource A depends on resource B and resource B depends on resource A. That is, the framework manager 440 will not instantiate two nodes 601 that are (erroneously) defined to depend on each other.

The acyclic property of the graph is important to prevent deadlocks, since, as described below, each node 601 is locked (in a transaction processing sense) when it is accessed. If two nodes 601 were to depend on each other in an instance in which a first thread were to access and lock one of these two nodes 601 at the same time that a second thread were to access and lock the other of these two nodes 601, both threads would be hung.

However, in the relatively rare instances in which a software developer or other such person involved in defining the software architecture deems it desirable to define in the software architecture two resources that depend on each other, the two (or more) resources may be included in the same node 601 as each other. Two resources in the same node will share the same lock state. It is at least in part for this reason that a software developer or other such person may choose to define a plural-resource node such as node 622 in the architecture.

Although this disclosure may, for purposes of clarity and convenience, reference a “node” 601 rather than a “resource” of the node 601, it should be understood that client requests may be directed to specified resources rather than nodes. In other words, a node 601, which, as described above, may be a data structure encapsulating of the functionality of one or more resources, may be transparent from the perspective of a client or other issuer of a client request such as another node 601. From the perspective of a client, a request is issued against a resource rather than a node. Likewise, from the perspective of a client, a state query, event, or other element of the architecture is associated with a resource rather than a node.

A resource graph such as the exemplary graph 400 is useful for understanding the instantiation of nodes 601 in accordance with dependencies, described below with regard to FIGS. 6-10. Leaf nodes, such as the nodes 642 and 646, are instantiated before non-leaf nodes, because leaf nodes have no dependencies. In general a node 601 must be instantiated before a node that depends on it may be instantiated. Furthermore, it can be seen that servicing a resource request corresponds to traversing a directed acyclic graph in which the vertices correspond to the nodes 601, the edges correspond to client requests 675, and adjacent nodes or vertices represent resource dependencies.

In a multi-processor PCD 100, a first processor may have access to or be capable of controlling a first set of nodes 601 in a first resource graph, while a second processor may have access to or be capable of controlling a second set of nodes 601 in a second resource graph, where the first and second resource graphs do not share any resources, i.e., they are mutually exclusive of resources. That is, in such an environment, each processor has its own resource graph that defines relationships among resources and other elements that are not accessible to other processors. The distributed resource management of the present disclosure relates to maintaining the relationships described above, such as dependencies and client requests, in instances in which two or more processors each have access to resources in their own resource graphs and do not have access to resources in other processors' resource graphs.

The above-referenced limitation upon access to resources may, in some embodiments, be limited by hardware configuration. That is, a processor may have no means by which it can affect a hardware device, such as a register, because the hardware device is controlled by or in the memory space of another processor. Alternatively, or in addition, the limitation upon access to resources may be imposed in software, for reasons such as minimizing exposure of a processor to security risks (e.g., a virus that may be infecting another processor).

FIG. 5 is a general diagram of another aspect of a software architecture 500B1 for a system that manages resources of a PCD 100 of FIG. 1. This aspect is described for purposes of clarity in the context of a PCD 100 and architecture in which all resources and other elements that are involved are controlled by the same processor, i.e., they are included in the same resource graph. In this general diagram, the one or more resources of each node 601 have not been provided with unique names. The node or resource graph 500B1 of FIG. 5 comprises only the nodes 601, clients 648, events 690, and query functions 695 supported by the architecture or framework manager 440. Each node 601 has been illustrated with an oval shape and arrows 680 with specific directions which represent respective dependencies between resources within a node 601.

FIG. 5 also illustrates how a client 648 of the first node 601A may issue a client request 675 to the first node 601A. After these client requests 675 are issued, the second node 601B may trigger an event 690 or provide a response to a query 695, in which messages corresponding to the event 690 and the query 695 flow back to the client 648.

FIG. 6 is a more specific diagram of the above-described aspect of the software architecture 500B1 for a system that manages resources of a PCD 100 of FIG. 1. FIG. 6 illustrates a node or resource graph 500B2 that comprises only the nodes 601 with specific, yet exemplary resource names, as well as clients 648, events 690, and query functions 695 corresponding to those of FIG. 3. Each node 601 has been illustrated with an oval shape and arrows 680 with specific directions which represent respective dependencies between resources within a node 601.

For example, the first node 602 has a dependency arrow 680B to indicate that the first node 602 is dependent upon the three resources of the second node 622. Similarly, the third resource “/bus/ahb/sysB/” comprising the second software element 444B and generally designated with the reference letter “C” in FIG. 11C has a dependency arrow 680C that indicates this third resource (C) is dependent upon the single “/clk/sys/ahb” resource of the fourth node 646.

FIG. 6 also illustrates the output data from nodes 601 which may comprise one or more events 690 or query functions 695. A query function 695 is similar to an event 690. The query function 695 may have a query handle that may or may not be unique. The query function is generally not externally identified and generally it does not have a state. The query function 695 may be used to determine the state of a particular resource of a node 601. The query function 695 and the events 690 may have relationships with an established client 648 and these relationships are represented by directional arrows 697 to indicate that information from respective event 690 and query function 695 are passed to a particular client 648.

The node or resource graphs 500B of FIG. 5-6 represent relationships which exist in memory under the control of a processor and which are managed by the framework manager 440. The node or resource graph 500B may be automatically generated by the framework manager 440 as a useful tool for identifying relationships between respective elements managed by the framework manager 440 and for troubleshooting by a software team.

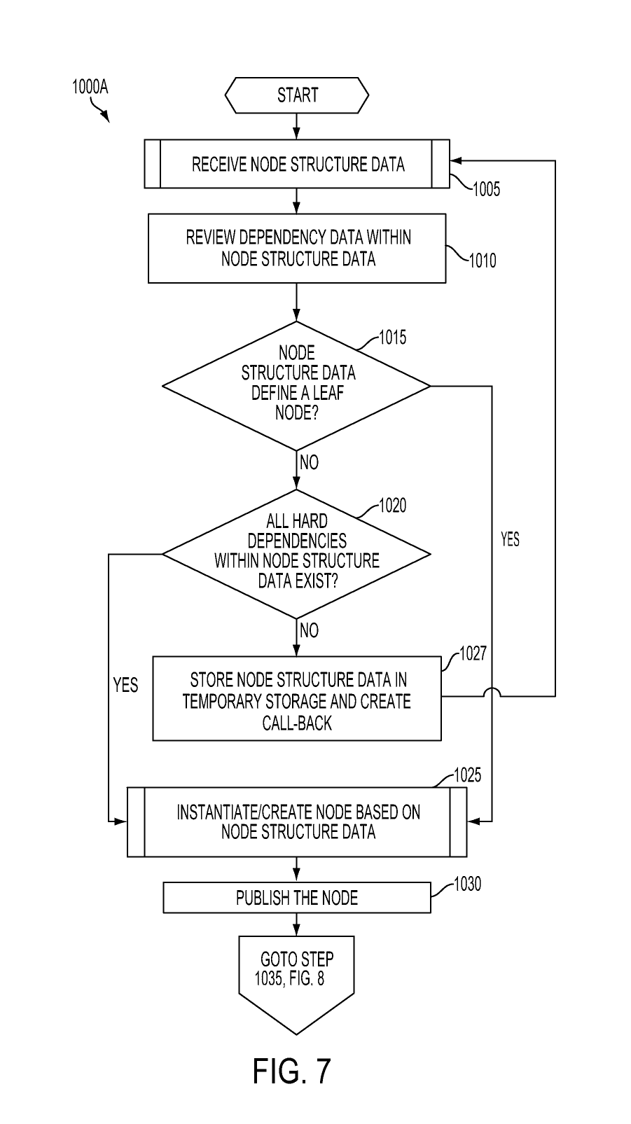

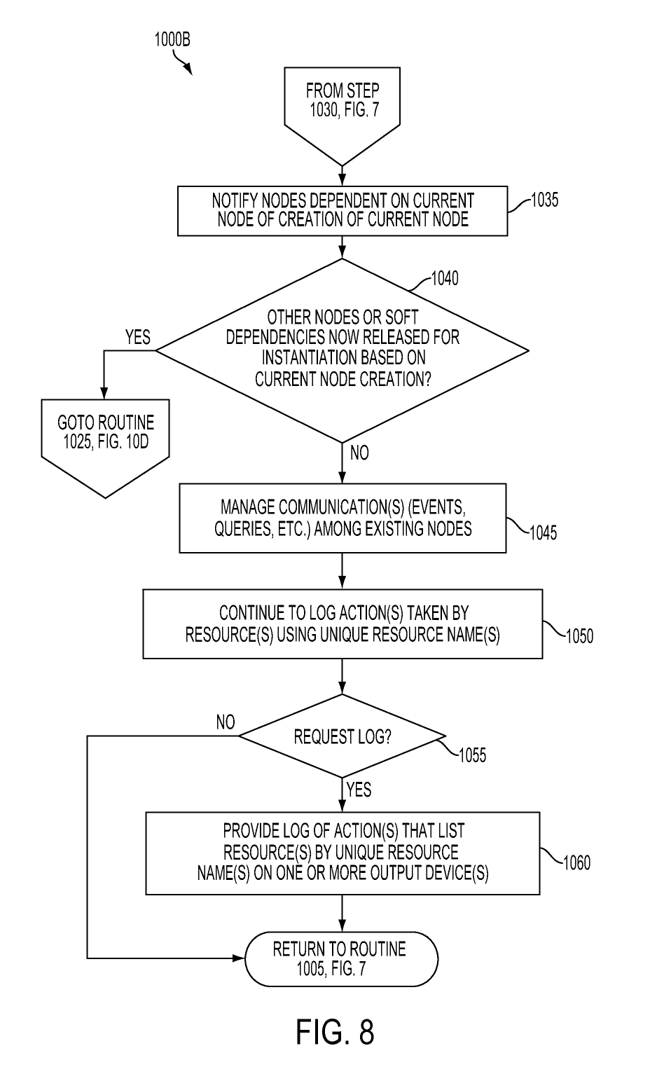

FIG. 7 is a flowchart illustrating a method 1000A for creating or instantiating software structures for managing resource(s) of a PCD 100. This method is described for purposes of clarity in the context of an architecture in which all resources and other elements that are involved are controlled by the same processor, i.e., they are included in the same resource graph.

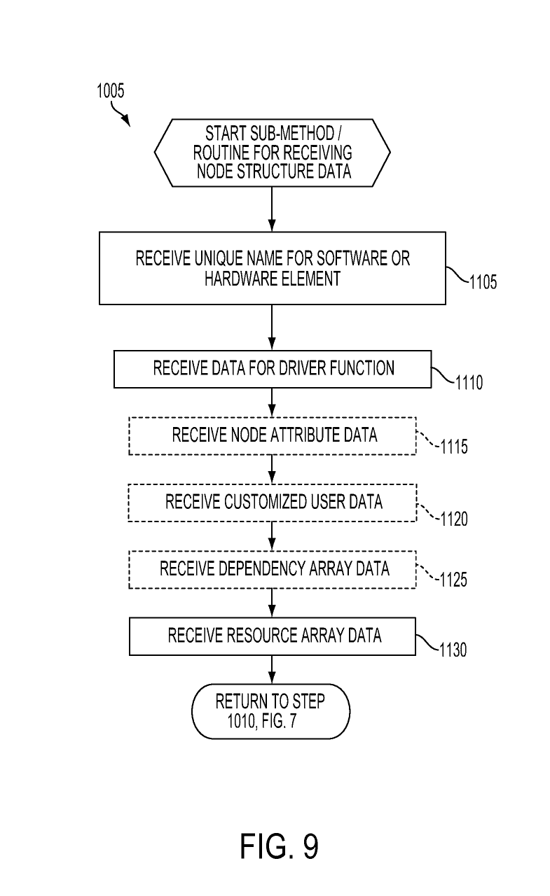

Block 1005 is the first routine of the method or process 1000 for managing resources of a PCD 100. In block 1005, a routine may be executed or run by the framework manager 440 for receiving node structure data. The node structure data may comprise a dependency array that outlines the dependencies a particular node 601 may have with other nodes 601. Further details about node structure data and this routine or submethod 1005 will be described in more detail below in connection with FIG. 9.

Next, in block 1010, the framework manager 440 may review the dependency data that is part of the node structure data received in block 1005. In decision block 1015, the framework manager 440 may determine if the node structure data defines a leaf node 601. A leaf node 601 generally means that the node to be created based on the node structure data does not have any dependencies, such as the nodes 642 and 646 in FIGS. 3-4. If the inquiry to decision block 1015 is positive, meaning that the node structure data for creating the current node does not have any dependencies, then the framework manager 440 continues to routine block 1025.

If the inquiry to decision block 1015 is negative, then the “No” branch is followed to decision block 1020 in which the framework manager determines if all of the hard dependencies within the node structure data exist. A hard dependency may comprise one in which a resource cannot exist without it. Meanwhile, a soft dependency may comprise one in which a resource may use the dependent resource as an optional step. A soft dependency means that a node 601 or resource of the node 601 which has a soft dependency may be created or instantiated within the node architecture even when the soft dependency does not exist.

An example of a soft dependency may comprise an optimization feature that is not critical to the operation for a resource oriented node 601 containing multiple resources. The framework manager 440 may create or instantiate a node or a resource for all hard dependencies that are present even when a soft is dependency is not present for those nodes or resources which have soft dependencies that are not created. A call back feature may be used to reference the soft dependency so that when the soft dependency becomes available to the framework manager 440, the framework manager 440 will inform each callback referencing the soft dependency that the soft dependencies are now available.

If the inquiry to decision block 1020 is negative, then the “No” branch is followed to block 1027 in which the node structure data is stored by the framework manager 440 in temporary storage such as memory and the framework manager 440 creates a call back feature associated with this un-instantiated node.

If the inquiry to decision block 1015 is positive, then the “Yes” branch is followed to routine 1025 in which a node 601 is created or instantiated based on the node structure data received in routine block 1005. Further details of routine block 1025 will be described below in connection with FIG. 9. Next, in block 1030, the framework manager 440 publishes the newly created node 601 using its unique resource name(s) so that other nodes 601 may send information to or receive information from the newly created node 601.

Referring now to FIG. 8, which is a continuation flow chart of FIG. 7, in block 1035, the framework manager 440 notifies other nodes 601 which are dependent on the newly created node 601 that the newly created node 601 has been instantiated and is ready to receive or transmit information. According to one exemplary aspect, notifications are triggered immediately when a dependent node, like node 601B of FIG. 5, is created, i.e., the notifications are performed recursively. So if node 601B of FIG. 5 is constructed, node 601A is immediately notified. This notification may allow node 601A to be constructed (since node 601B was node 601A′s final dependency). Construction of node 601B may causes other nodes 601 to be notified, and so on. Node 601B does not get completed until the final resource dependent on node 601B is completed.

A second, slightly more complex, implementation is to put all of the notifications onto a separate notification queue, and then run through the queue beginning at a single point in time, i.e., the notifications are performed iteratively. So when node 601B of FIG. 5 is constructed, the notification to node 601A is pushed onto a list. Then that list is executed and node 601A is notified. This causes the notification to other additional nodes 601 (besides node 601A, not illustrated in FIG. 5) to be put on the same list, and that notification is then sent after the notification to node 601A is sent. The notifications to other nodes 601 (besides the notification to node 601A) does not occur until after all the work associated with node 601B and node 601A has been completed.

Logically, these two implementations are equivalent, but they have different memory consumption properties when implemented. The recursive realization is simple but can consume an arbitrary amount of stack space, with the stack consumption being a function of the depth of the dependency graph. The iterative implementation is slightly more complex and requires a bit more static memory (the notification list), but stack usage is constant irrespective of the depth of a dependency graph, such as illustrated in FIG. 5.

Also, notification of node creation in block 1035 is not limited to other nodes. It may also used internally for alias construction. Any arbitrary element in the system 500A may use the same mechanism to request for notification when a node becomes available, not just other nodes. Both nodes and non-nodes may use the same notification mechanism.

In decision block 1040, the framework manager 440 determines if other nodes 601 or soft dependencies are now released for creation or instantiation based on the creation of the current node 601. Decision block 1040 generally determines whether resources may be created because certain dependency relationships 680 have been fulfilled by the current node which has recently undergone creation or instantiation.

If the inquiry to decision block 1040 is positive, then the “Yes” branch is followed back to routine block 1025 in which the released node 601 may now be created or instantiated because of the fulfillment of a dependency by the node 601 that was just created.

If the inquiry to decision block 1040 is negative, then the “No” branch is followed to block 1045 in which the frame work manager 440 may manage communications between elements of the software architecture as illustrated in FIG. 2. Next, in block 1050, the framework manager 440 may continue to log or record actions taken by resources by using the resource names associated with a particular resource. Block 1045 may be executed by the framework manager 440 after any action taken by the framework manager 440 or any of the elements managed by the framework manager 440, such as the resources, nodes 601, clients 648, events 695, and query functions 697. Block 1045 shows another aspect of the node architecture in which the framework manager 440 may maintain a running log of activity that lists actions performed by each element according to their unique identifier or name provided by the authors who created a particular element, such as a resource of a node 601.

Compared to the prior art, this logging of activity in block 1050 that lists unique names assigned to each resource of a system is unique and may provide significant advantages such as used in debugging and error troubleshooting. Another unique aspect of the node architecture 500A is that separate teams may work on different hardware and/or software elements independently of one another in which each team will be able to use resource names that are unique and easy to track without the need for creating tables to translate less meaningful and usually confusing resource names assigned by other teams and/or the original equipment manufacturer (OEM).

Next, in decision block 1055, the framework manager 440 determines if a log of activity recorded by the framework manager 440 has been requested. If the inquiry to decision block 1055 is negative, then the “No” branch is followed to the end of the process in which the process returns back to routine 1005. If the inquiry to decision block 1055 is positive, then the “Yes” branch is followed to block 1060 in which the framework manager 440 sends the activity log comprising meaningful resource names and respective actions performed by the resource names to an output device, such as a printer or a display screen and/or both. The process then returns to routine block 1005 described above.

FIG. 9 is a flowchart illustrating a sub-method or a routine 1005 of FIG. 7 for receiving node structure data that defines a software architecture of a PCD 100. The receiving method may occur at any suitable time, such as, for example, when the PCD 100 is started up or initialized. In such an instance, the node structure data is received when a processor reads the corresponding software code from memory in preparation for instantiating the nodes 601 in accordance with the architecture.

Block 1105 is the first step in the sub method or routine 1005 of FIG. 7. In block 1105, the framework manager 440 may receive a unique name for a software or hardware element, such as the CPU 110 and the clock 442 of FIG. 7. As discussed previously, a node 601 must reference at least one resource. Each resource has a unique name in the system 500A. Each element within the system 500A may be identified with a unique name. Each element has a unique name from a character perspective. In other words, generally, there are no two elements within the system 500A which have the same name. According to exemplary aspects of the system, resources of nodes 601 may generally have unique names across the system, but it is not required that client or event names be unique, though they may be unique as desired.

For convenience, a conventional tree file naming structure or file naming “metaphor” that employs forward slash “/” characters for creating unique names may be employed, such as, but not limited to, “/core/cpu” for CPU 110 and “/clk/cpu” for clock 442. However, as recognized by one of ordinary skill the art, other types of resource names containing any other combination of alphanumeric characters and/or symbols are well within the scope of this disclosure.

Next, in block 1110, the framework manager 440 may receive data for one or more driver functions associated with one or more resources of the node 601 being created. A driver function generally comprises the action to be completed by one or more resources for a particular node 601. For example, in FIG. 6, the driver function for the resource /core/cpu of node 602 may request the amount of bus bandwidth and the CPU clock frequency it requires in order to provide the requested amount of processing that has been requested. These requests would be made via clients of the resources in nodes 642 and node 622. The driver function for /clk/cpu in node 642 would usually be responsible for actually setting the physical clock frequency in accordance with the request it received from the /core/cpu resource of node 602.

In block 1115, the framework manager 440 may receive node attribute data. The node attribute data generally comprises data that defines the node policies such as security (can the node be accessed via user space applications), remotability (can the node be accessed from other processors in the system) and accessibility (can the resource support multiple concurrent clients). The framework manager 440 may also define attributes that allow a resource to override default framework behavior, such as request evaluation or logging policy.

Subsequently, in block 1120, the framework manager 440 may receive customized user data for the particular node 601 being created. The user data may comprise a void “star” field as understood by one of ordinary skill in the art with respect to the “C” programming language. User data is also known to one of ordinary skill in the art as a “trust me” field. Exemplary customized user data may include, but is not limited to, tables such as frequency tables, register maps, etc. The user data received in block 1120 is not referenced by the system 500B, but allows for customization of a resource if the customization is not recognized or fully supported by the framework manager 440. This user data structure is a base class in the “C” programming language intended to be extended for particular or specific uses.

One of ordinary skill the art recognizes that other kinds of data structures for extending specific uses of a particular class are within the scope of this disclosure. For example, in the programming language of “C++” (C-plus-plus), an equivalent structure may comprise the key word “public” which would become an extension mechanism for a resource within a node 601.

Next, in block 1125, the framework manager 440 may receive dependency array data. The dependency array data may comprise the unique and specific names of one or more resources 601 on which the node 601 being created is dependent. For example, if the first node 602 of FIG. 6 was being created, then in this block 1125, the dependency array data may comprise the resource names of the three resources of the second node 622 and the single resource name of the third node 642 on which the first node 602 is dependent.

Subsequently, in block 1130, the framework manager 440 may receive resource array data. The resource array data may comprise parameters for the current node being created, such as parameters relevant to the first node 602 of FIGS. 7B-7C if this first node 602 was being created. The resource array data may comprise one or more of the following data: the names of other resources; unit; maximum value; resource attributes; plug-in data; and any customized resource data similar to the customize user data of block 1120. The plug-in data generally identifies functions retrieved from a software library and usually lists the client types that may be supported by the particular node or plurality of nodes being created. The plug-in data also allows for customization of client creation and destruction. After block 1130, the process returns to block 1010 of FIG. 7.

In FIG. 9, the attribute data block 1115, customized user data block 1120, and the dependency array data block 1125 have been illustrated with dashed lines to indicate that these particular steps are optional and not required for any given node 601. Meanwhile, the unique name block 1105, a driver function block 1110, and resource array data block 1130 have been illustrated with solid lines to indicate that these steps of routine 1005 are generally important for creating a node 601.

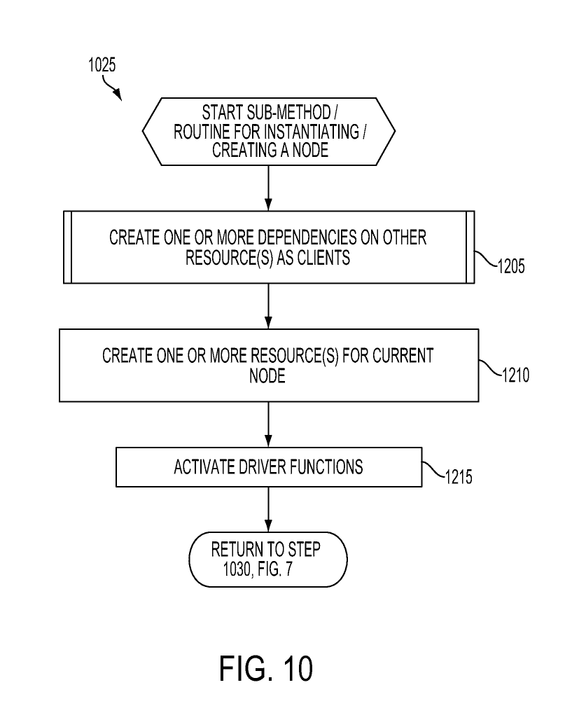

FIG. 10 is a flowchart illustrating a sub-method or a routine 1025 of FIG. 7 for creating a node in a software architecture for a PCD 100. Routine block 1205 is the first routine in the sub-method or routine 1025 for instantiating or creating a node 601 according to one exemplary embodiment. In routine block 1205, one or more clients 648 that are associated with the node 601 being instantiated are created in this step. Further details about routine block 1205 will be described in further detail below in connection with FIG. 11.

In block 1210, the framework manager may create or instantiate the one or more resources corresponding to the node structure data of block 705. Next, in block 1215, the framework manager 440 may activate the driver functions received in routine block 1110 of routine block 1005. According to one exemplary aspect, the driver functions may be activated using the maximum values received in the resource array data block 1130 of routine block 1005. According to another, preferred, exemplary aspect, each driver function may be activated with an optional, initial value that is passed along with the node structure data from routine 1005. If initial data is not provided, the driver function is initialized at 0—the minimum value. The driver function is also usually activated in manner such that it is known that it is being initialized. This enables the resource to perform any operations that are specific to initialization, but do not need to be performed during normal or routine operation. The process then returns to step 1030 of FIG. 7.

FIG. 11 is a flowchart illustrating a sub-method or a routine 1205 of FIG. 10 for creating or instantiating a client 648 in a software architecture of a PCD 100. Block 1305 is the first step of routine block 1205 in which a client 648 of one or more resources 601 is created. In block 1205, the framework manager 440 receives a name assigned to the client 648 being created. Similar to resource names, the name for a client 648 may comprise any type of alphanumeric and/or symbols.

Next, in block 1310, customized user data may be received by the framework manager 440 if there are any particular customizations for this client 648 being created. Block 1310 has been illustrated with dashed lines to indicate that the step is optional. The customized user data of block 1310 is similar to the customized user data discussed above in connection with the creation of resources for nodes 601.

In block 1315, the framework manager 440 receives the client type category assigned to the particular client being created. The client type category as of this writing may comprise one of four types: (a) required, (b) impulse, (c) vector, and (d) isochronous. The client type category list may be expanded depending upon the resources being managed by the system 101 and upon the application programs relying upon the resources of the nodes 601.

The required category generally corresponds with the processing of a scalar value that is passed from the required client 648 to a particular resource 601. For example, a required request may comprise a certain number of millions of instructions per second (MIPs). Meanwhile, the impulse category generally corresponds with the processing of a request to complete some activity within a certain period of time without any designation of a start time or stop time.

An isochronous category generally corresponds with a request for an action that is typically reoccurring and has a well-defined start time and a well-defined end time. A vector category generally corresponds with an array of data that usually is part of multiple actions that are required in series or in parallel.

Subsequently, in block 1320, the framework manager 440 receives data that indicates whether the client 648 has been designated as synchronous or asynchronous. A synchronous client 648 is one that typically requires the framework manager 440 to lock a resource of a node 601 until the resource 601 returns data and an indication that the resource 601 has finished completing the requested task from the synchronous client 648.

On the other hand, an asynchronous client 648 may be handled by one or more threads in parallel which are accessed by the framework manager 440. The framework 440 may create a callback to a thread and may return a value when the callback has been executed by a respective thread. One of ordinary skill the art recognizes that the asynchronous client 648 does not lock up a resource like a synchronous client 648 does when the task of the synchronous client 648 is being executed.

After block 1320, in decision block 1325, the framework manager 440 determines if the resource identified by the client 645 are available. If the inquiry to decision block 1325 is negative, then the “No” branch is followed to block 1330 in which a null value or message is returned to a user indicating that the client 648 cannot be created at this time.

If the inquiry to decision block 1325 is positive, then the “Yes” branch is followed to decision block 1335 in which the framework manager 440 determines if each resource identified by the client 648 supports the client type provided in block 1310. If the inquiry to decision block 1335 is negative, then the “No” branch is followed back to block 1330 in which a null value or message is returned indicating that the client 648 cannot be created at this time.

If the inquiry to decision block 1335 is positive, then the “Yes” branch is followed to block 1340 in which the framework manager 440 creates or instantiates the client 648 in memory. Next, in block 1345, if any customized user data is received in block 1310, such as optional arguments, then these optional arguments may be mapped with their respective resources to a particular node 601. Next, in block 1350, the newly created client 645 is coupled to its corresponding one or more resources in an idle state or on requested state as described above. The process then returns to block 1210 of FIG. 10.

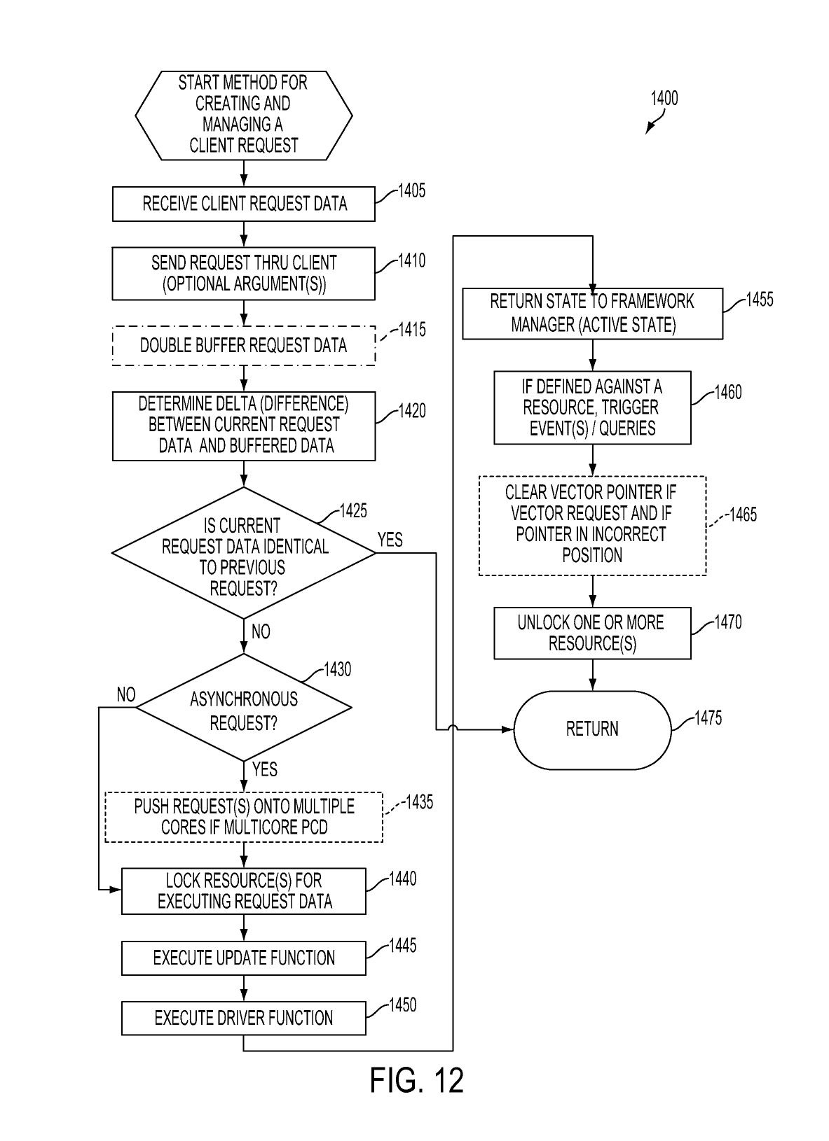

FIG. 12 is a flow chart illustrating a method 1400 for creating a client request 675 against a resource 601 in a software architecture for a PCD 100. The method 1400 is generally executed after client and node creation (instantiation) as described above in connection with FIGS. 7-11.

Block 1405 is the first step in the method 1400 for creating a client request 675 against the resource 601. This method 1400 will describe how the following three types of client requests 675 are handled by the framework manager 440: (a) required, (b) impulse, and (c) vector. As the names of the requests 675 mentioned above suggest, client requests 675 generally correspond with client types that were created and described above.

In block 1405, the framework manager 440 may receive the data associated with a particular client request 675 such as one of the three mentioned above: (a) required, (b) impulse, and (c) vector. The data associated with a required request generally comprises a scalar value that is passed from the required client 648 to a particular resource 601. For example, a required request may comprise a certain number of millions of instructions per second (MIPs). An impulse request comprises a request to complete some activity within a certain period of time without any designation of a start time or stop time.

Data for a vector request generally comprises an array of multiple actions that are required to be completed in series or in parallel. A vector request may comprise an arbitrary length of values. A vector request usually has a size value and an array of values. Each resource of a node 601 may be extended to have a pointer field in order to support a vector request. In the “C” programming language, the pointer field is supported by the union function as understood by one of ordinary skill in the art.

Next, in block 1410, the framework manager 440 issues the request through the client 648 that was created by the method described above in connection with FIG. 11. Subsequently, in block 1415, the framework manager 440 double buffers the request data being passed through the client if the request is a required type or a vector type. If the request is an impulse type, then block 1415 is skipped by the framework manager 440.

For required requests, in this block 1415, values from a prior request are maintained in memory so that the framework manager 440 may determine if there is any difference between the previous requested values in the current set of requested values. For vector requests, prior requests are usually not maintained in memory, although a resource of a node 601 may maintain it as desired for a particular implementation. Therefore, block 1415 is optional for vector types of requests.

In block 1420, the framework manager 440 calculates the delta or difference between the previous set of requested values in the current set of requested values. In decision block 1425, the framework manager determines if the current set of requested values is identical to the previous set of requested values. In other words, the framework manager 440 determines if a difference exists between the current set of requested values and the previous set of requested values. If there is no difference between the current set and previous set of requested values, then the “Yes” branch is followed (which skips blocks 1430 through block 1470) to block 1475 in which the process ends.

If the inquiry to decision block 1425 is negative, meaning that the set of requested values are different relative to the set of pre-previous requested values, then the “No” branch is followed to decision block 1430.

In decision block 1430, the framework manager 440 determines if the current request is an asynchronous request. If the inquiry to decision block 1430 is negative, then the “No” branch is followed to block 1440 in which the resource 601 corresponding to the client request 675 is locked by the framework manager 440. If the inquiry to decision block 1430 is positive, meaning that the current request is asynchronous request type, then the “Yes” branch is followed to block 1435 in which the request may be pushed onto another thread and may be executed by another core if a multi-core system, like that of FIG. 1, is currently managed by the framework manager 440. Block 1435 has been illustrated with dashed lines to indicate that this step may be optional if the PCD 100 is a single core central processing system.

Subsequently, in block 1440, the resources 601 corresponding to the request 675 is locked by the framework manager 440. Next, in block 1445, the resource 601 executes the update function which generally corresponds to the plug-in data of the resource array data received in block 1130 of FIG. 9. The update function generally comprises a function responsible for the new resource state in light of a new client request.

The update function compares its previous state with the requested state in the client request. If the requested state is greater than the previous state, then the update function will perform the client request. However, if the requested state is equal to or less than the current state and which the resource is operating at, then the client request will not be performed in order to increase the efficiency since the old state achieves or satisfies the requested state. An update function takes a new request from the client and aggregates it with all the other active requests to determine the new state for the resource.

As an example, multiple clients may be requesting a bus clock frequency. The update function for the bus clock would usually take the maximum of all the client requests and use that as the new desired state for the bus clock. It is not the case that all resources will use the same update function, although there are some update functions that will be used by multiple resources. Some common update functions are to take the maximum of client requests, to take the minimum of client requests and to sum the client request. Or resources may define their own custom update function if their resource needs to aggregate requests in some unique way.

Next, in block 1450, the framework manager 440 passes the data to the resource corresponding to the client 648 so that the resource may execute the driver function which is specific to the resource of a node 601. A driver function applies the resource state as computed by the update function. This may entail updating hardware settings, issuing requests to dependent resources, calling legacy functions or some combination of the above.

In the previous example, the update function computed the requested bus clock frequency. The driver function may receive that requested frequency and it may update the clock frequency control HW to run at that frequency. Note that sometimes it is not possible for the driver function to meet the exact requested state that update function has computed. In this case, the driver function may choose the frequency that best meets the request. For example, the bus clock HW may only be able to run at 128 MHz and 160 MHz, but the requested state might be 150 MHz. In this case, the driver function should run at 160 MHz, as that exceeds the requested state.

Next, in block 1455, the framework 440 receives state control from the resource which has executed the driver function in block 1450. Subsequently, in block 1460, if defined against the resource, events 690 may be triggered so that data is passed back to the client 648 which corresponds to the event 690. Events may be processed in another thread. This may minimize the amount of time spent with the resources locked and allows for parallel operation in a multi-core system as illustrated in FIG. 1.

One or more events 690 may be defined against a resource in a manner similar to how a request may be defined against a resource as described in this method 1400. In other words, the event creation process may largely parallel the client creation process. One thing that is different with the events is that it is possible to define events that only get triggered when certain thresholds are crossed.

This defining of events that only get triggered based on thresholds allows for notification of when a resource is getting oversubscribed (it has more concurrent users than it can support) which is indicative of a system overloading condition, or when a resource goes low/off, which may allow other things to be shut off, restore functionality that was disabled when the system became oversubscribed, etc. Because the event registration may be done with thresholds, it reduces the amount of work the system has to do on event notification to only happen when there is something really necessary. It is also possible to register for an event on every state change.

Next, in optional block 1465, if the request being processed is a vector request, then this optional block 1465 is usually performed. Optional block 1465 generally comprises a check or determination to assess whether the vector pointer is still positioned on the same data that the user passed into the vector. If the inquiry to this optional block 1465 is positive, meaning that the pointer is still pointing to the same data which was passed by the user into the vector, then the pointer is cleared out so that references to old data is not maintained. This optional block 1465 is generally performed to account for the double buffering block 1415 described above when a vector request is being processed, compared to an impulse request and a required request.

Subsequently, in block 1470, the framework 440 unlocks the requested resource so that other client requests 648 may be handled by the current but now released requested resource of a particular node 601. The process then returns to the first block 1405 for receiving the next client request.

The above-described methods and data structures are essentially as applicable to a multi-processor PCD 100 as they are to a single-processor PCD 100. However, the remoting framework 300 (FIG. 3) may provide additional features that may enhance operation in a multi-processor embodiment.

For example, the remoting framework 300 may advantageously render the details of inter-processor communication transparent to an application programmer or similar person. Thus, an application program, for example, may define a client that issues a request on a target resource without having to include in the client definition any identification of the processor domain that controls that resource. Rather, the remoting framework 300 ensures that the request will reach the target resource regardless of which processor controls the client and which processor controls the target resource.

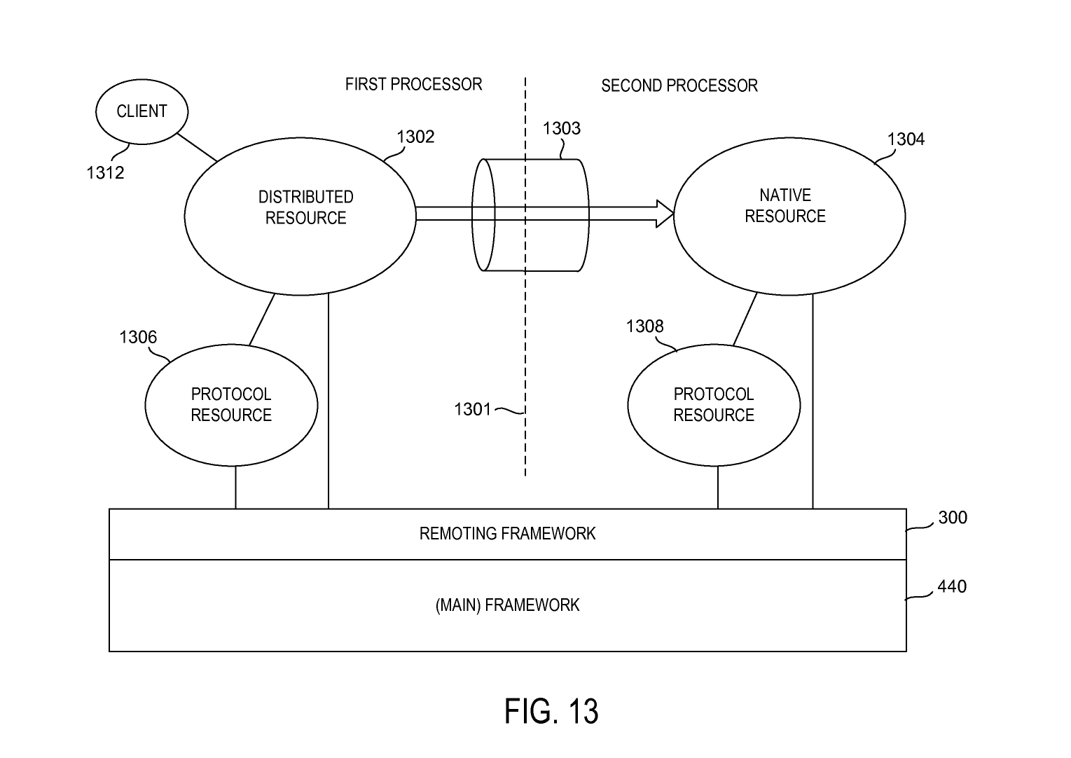

In addition, the remoting framework 300 manages the inter-processor communication so that, for example, an application program need not include any instructions relating to the protocol or other aspects of the communication paths (e.g., buses) between processors. Furthermore, as different inter-processor communication paths may use different protocols, the remoting framework 300 allows the resource definition to specify a protocol along with other aspects of the resource. These and other features relating to distributed resource management are described below with regard to FIG. 13.

FIG. 13 illustrates an example or instance in which a first resource 1302, which is controlled by a first processor (not shown) serves as a distributed or remote resource corresponding to a second resource 1304, which is controlled by a second processor (not shown). The term “distributed resource” or “remote resource” is used in this disclosure to refer to a resource on one processor that corresponds to a “native” resource on another processor. The second resource 1304 in this example serves as a native resource to the second processor.

A distributed resource is used as a means to access the corresponding native resource. In this example the term “resource” may be used interchangeably with the term “node,” as it should be understood that a resource may be included in a node.

A broken line 1301 illustrates a division between resources controlled by the first processor (to the left of the line 1301) and resources controlled by the second processor (to the right of the line 1301). The first resource 1302 is one of two or more resources that are controlled by the first processor. One such resource may be a protocol resource 1306 on which the first resource 1302 depends. Likewise, the second resource 1304 is one of two or more resources that are controlled by the second processor. One such resource may be a protocol resource 1308 on which the second resource 1304 depends.

The first and second resources 1302 and 1306 may also depend on additional resources in the same manner as described above with regard to resources or nodes in general, but such additional resources are not shown in FIG. 13 for purposes of clarity. Note that the resources controlled by the first processor are defined by a first resource graph (i.e., a directed acyclic graph), and the resources controlled by the second processor are defined by a second such resource graph that does not share any resources with the first resource graph.

The first and second resources 1302 and 1304, under control of their respective processors, are capable of communicating information via a communication path 1303. The communication path 1303 represents the combination of the physical medium between the first and second processors and the one or more layers of transport protocols used to communicate via that medium. Accordingly, any communications between the first resource 1302 and the second resource 1304 must conform to the protocols. Protocol resources 1306 and 1308 define a protocol or may point to a protocol definition in a library (not shown). The remoting framework 300 and (main) framework 440 operate in conjunction with one another to manage the resources and communications between them. As described below, a client 1312, under control of the first processor, may issue one or more resource requests on the first resource 1302. The first resource 1302 uses the functionality of the corresponding second resource 1304 to service the resource request.

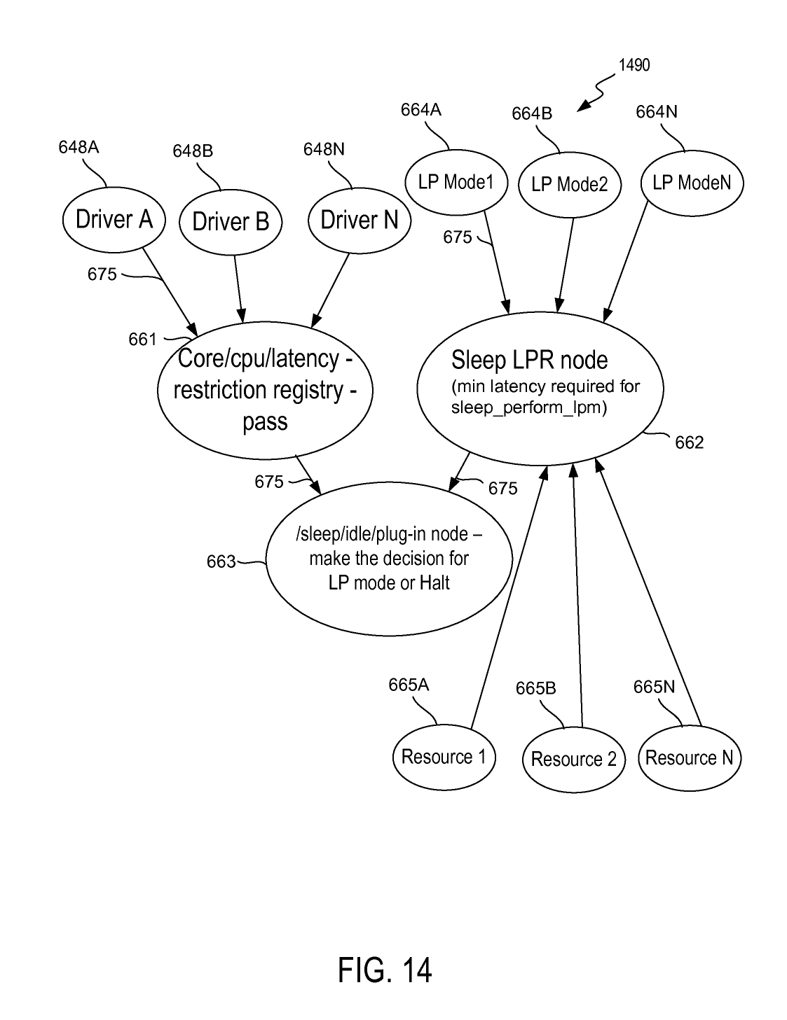

FIG. 14 illustrates a portion of a sleep subsystem 1490 for tracking one or more conditions and for selecting an optimal power conserving mode of a processor 110 based on those conditions. The subsystem 1490 may comprise a latency restriction tracking node 661 and a sleep low power resource (“LPR”) node 662 that are operatively linked to a sleep idle plug-in node 663.

The latency restriction tracking node 661 may be assigned a resource name of “core/cpu/latency—restriction registry—pass.” However, other resource names for the latency restriction tracking node 661 may be employed without departing from the scope of this disclosure.

Different software drivers may each have a latency restriction which is registered with the latency restriction node 661. A latency restriction is a restriction on the amount of time calculated between the instant an interrupt fires/initiates to an instant in time an interrupt service request (“ISR”) may be run or executed by a processor 110 to handle an interrupt. Typically, different clients 648A-N, such as drivers as illustrated in FIG. 14, register their latency restrictions with this latency restriction tracking node 661.

The clients 648A-N which register their latency restrictions with the latency restriction tracking node 661 are not limited to drivers and may include any other type of resource of a PCD 100. However, drivers are resources that are usually most concerned about interrupts and how they are serviced by the sleep subsystem 1490 of a PCD 100.

As understood by one of ordinary skill in the art, a latency restriction is usually provided in some units of time that may vary from one operating system (“OS”) to the next. According to one exemplary embodiment, each latency restriction from a client 648A-N may be provided in units of a clock frequency such as in kilohertz. In other exemplary embodiments, the latency restriction may be expressed in microseconds, nanoseconds, etc.

An example of how a latency restriction is used in a context for a PCD 100 is described as follows: if a processor 110 of a PCD 100 is in a low-power mode such as CPU power collapse, and an interrupt fires to wake up the processor 110, then the amount of time that is needed to exit the power collapse mode causes latency for servicing that interrupt. This latency occurs because the processor 110 usually must run some cleanup processes after the CPU power collapse mode before the interrupt service request (“ISR”) may be activated so that the processor 110 can service the interrupt.

A PCD 100 may have one or more low-power modes tracked by nodes 664 as illustrated in FIG. 14. These low-power modes tracked by nodes 664 may comprise a range of different sleep states and may consume different levels or degrees of power as understood by one of ordinary skill in the art. Stated differently and for context, a “low-power mode” refers to an operation of a PCD 100 which typically consumes less power than a “normal” or “regular” operation in which a processor 110 is active and is performing one or more tasks as understood by one of ordinary skill in the art. Usually, during a low-power mode of operation, a processor 110 is not provided with any tasks or functions to perform.

Each low-power mode tracked by a node 664 is usually registered by a resource with the sleep LPR node 662 (described below) and indicates how much time is taken to enter into the low-power mode tracked by a node 664 and how much time is needed to exit the low-power mode. If a low-power mode takes longer to enter and exit than a latency restriction allows, then that low-power mode may not be chosen by a solver function or code executed by a processor 110.

Meanwhile, one of the main functions of the latency restriction tracking node 661 is to detect new and/or changes in latency restrictions and to pass that data to the sleep idle plug-in node 663. Complimentary to the latency restriction tracking node 661, the sleep LPR node 662 keeps track of all the low-power modes (taking the form of nodes 664A, 664B, and 664N) that are registered with a sleep subsystem 1490 of PCD 100.

The sleep LPR node 662 determines which enabled low-power node tracked with a node 664 has the minimum amount of time to enter and exit its respective sleep state. The sleep LPR node 662 tracks all of the low-power modes tracked by nodes 664 that are registered with the sleep subsystem 1490 of a PCD 100, and which were created by respective low power resources 665. Various low power resources 665 may register with the sleep LPR node 662 to inform of their low power modes which may be tracked with nodes 664. Exemplary low power resources 665A, 665B, 665N may include, but are not limited to, a CPU rail (off or power collapse), various low powered resources that each have their own respective low-power modes of operation, a CXO clock that may be a clock for an entire chip (Shut down/OFF), a main voltage rail for the digital domain (a low power mode that is minimized or characterized as a retention level).

One of the main functions of the sleep LPR node 662 is to detect enablement of any of the lower power modes tracked by nodes 664. “Enabled” as understood by one of ordinary skill in the art means that the resource which controls or is in charge of a respective low-power mode tracked by a node 664 has determined that there are no conditions which prevent a processor 110 from entering this low-power mode tracked by a node 664. The enabled condition allows a processor 110 to select a particular low-power mode tracked by a node 664 as an option if certain conditions are right/optimal.

Specifically, an enabled condition of a low-power mode tracked by a node 664 allows a solver, which is typically code and/or function executed by a processor 110, to select one of the enabled low-power modes tracked by a node 664 based on current/present conditions of the PCD 100. The solver (not illustrated) typically comprises a decision process executed by the PCD 100 for selecting an optimal low-power mode tracked by a node 664 that is enabled and based on current conditions of the PCD 100.

In addition to detecting whether a low-power mode tracked by a node 664 has been enabled, the sleep LPR node 662 also identifies which enabled low power mode tracked by a node 664 has the minimum entry and exit latency out of all enabled low-power modes registered with the sleep LPR node 662. Entry and exit latency refers to how each low-power mode tracked by a node 664 has a predetermined amount of time that a processor 110 will take to enter and exit the respective low-power mode. The sleep LPR node 662 may compare entry and exit latency values across enabled low-power modes tracked by nodes 664 in order to determine the one with the least amount of required time (latency), referred to as the minimum entry and exit latency for a low-power mode. The sleep LPR node 662 relays this minimum entry and exit latency to the sleep idle plug-in node 663 whenever it detects a new low power mode that has been enabled. The sleep LPR node 662 also detects when no low power modes are enabled. It communicates this status to the sleep idle plug-in node 663.

The sleep idle plug-in node 663 is responsible for determining whether the lowest latency restriction is less than the minimum enabled low-power mode latency that has been detected and identified by the sleep LPR node 662. In other words, the sleep idle plug-in node 663 determines if any low-power mode may be possible for a processor 110. The sleep idle plug-in node 663 determines whether it is worth it for a processor 110 to initiate a solver to determine which low-power state should be selected based on the available low-power modes registered with the sleep LPR node 662. The sleep idle plug-in node 663 determines very early on whether a solver would be able to choose a low-power mode at all based on present operating conditions of a PCD 100.

By doing this, the sleep idle plug-in node 663 may determine which enabled low-power mode is the fastest to enter into and exit from (the minimum enter and exit latency). So if a low-power mode tracked by a node 664 with the minimum enter and exit latency violates the latency restrictions registered with the latency restriction tracking node 661, then the sleep idle plug-in node 663 will know that none of the enabled low-power modes tracked by nodes 664 will be available to the processor 110 at this current or present time based on the present conditions of the PCD 100.

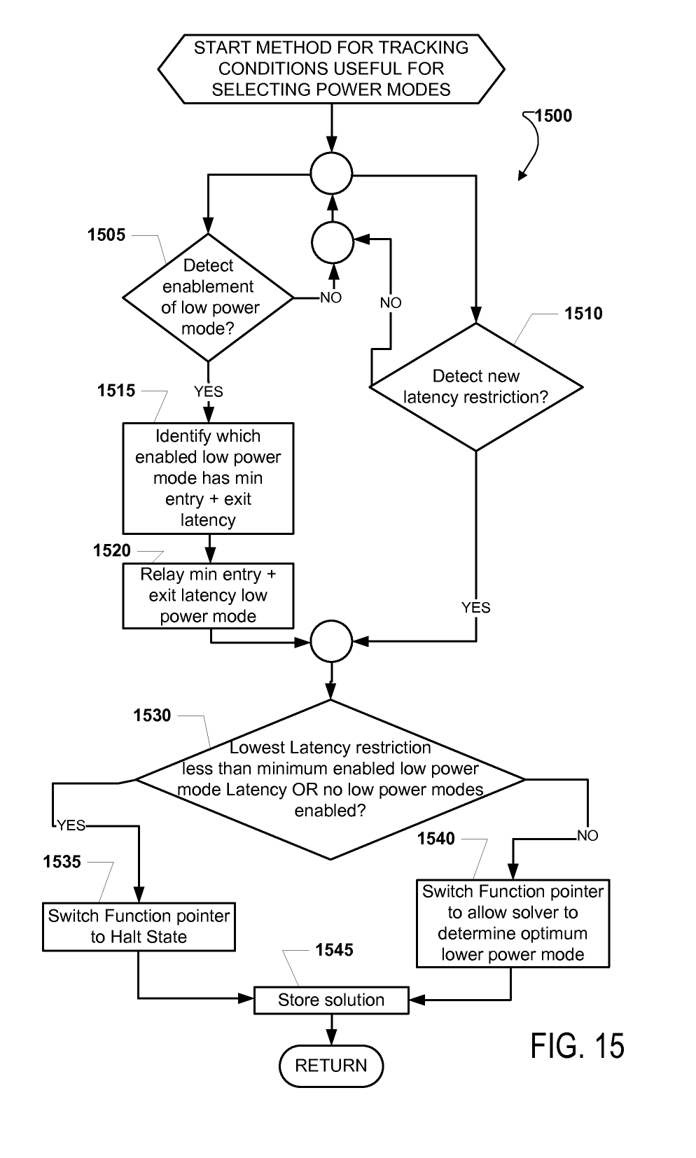

In such a situation, where no enabled low-power modes are available, the sleep idle plug-in node 663 will recommend (switch its function pointer to) the halt state. If an enabled low-power mode tracked by a node 664 having a minimum enter and exit latency does not violate the lowest latency restriction registered with the latency restriction tracking node 661, then the sleep idle plug-in node 663 will know that at least one enabled low-power mode may be available to the processor 110 and that such a low-power mode may be selected by a solver in a subsequent process. The functions of the sleep idle plug-in node 663 will become more apparent in connection with the flowchart of FIG. 15 described below.

FIG. 15 is a logical flowchart illustrating a method 1500 for tracking one or more conditions useful for selecting optimal power conserving modes of a processor 110 of a PCD 100 and switching a function pointer to a halt state when it is detected that no modes are enabled. Blocks 1505 and 1510 are the first blocks of method 1500. In other words, this means that blocks 1505 and 1510 may be performed in parallel as understood by one of ordinary skill in the art.

In decision block 1505, the enablement of any low-power mode tracked by a node 664 is detected. Block 1505 may be performed or executed by the sleep LPR node 662 as described above. Meanwhile, in parallel to decision block 1505, in decision block 1510, any new latency restrictions are detected. Decision block 1510 may be performed or executed by the latency restriction tracking node 661 as described above in connection with FIG. 14.

If the inquiry to decision block 1510 is negative, then the “NO” branch is followed back such that decision blocks 1505 and 1510 may be executed again. Similarly, if decision block 1505 is negative, then the “NO” branch is followed back such that decision blocks 1505 and 1510 may be executed again. However, if the inquiry to decision block 1510 is positive, then the “YES” branch is followed to decision block 1530.

If the inquiry to decision block 1505 is positive, then the “YES” branch is followed to block 1515. In block 1515, the single enabled low-power mode which has the minimum entry and exit latency is identified. Block 1515 is usually performed by the sleep LPR node 662 as described above in connection with FIG. 14. Next, in block 1520, the enabled low-power mode tracked by a node 664 which has the minimum entry and exit latency that was identified in block 1515 is then relayed to the sleep idle plug-in node 663 in block 1520. Block 1520, like blocks 1515 and 1505, is usually executed or performed by the sleep LPR node 662 described above.

In decision block 1530, it is determined whether the lowest latency restriction detected in block 1510 is less than the minimum latency for the enabled low-power mode tracked by a node 664 that was detected and relayed via blocks 1505 through 1520. Decision block 1530 may also detect if there are no low power modes enabled. This decision block 1530 is usually performed or executed by the sleep idle plug-in node 663. If the inquiry to decision block 1530 is positive, which means that the lowest latency restriction detected in decision block 1510 is less than (more restrictive) then the latency of the enabled low-power mode with the lowest latency OR if no low power modes have been enabled, then the “YES” branch is followed to block 1535 in which the sleep idle plug-in node 663 switches its function pointer to a “HALT” state.

If the inquiry to decision block 1530 is negative, which means that the latency of the enabled low-power mode with the lowest latency is less than the lowest latency restriction identified in block 1510, then the “NO” branch is followed to block 1540. In block 1540, the sleep idle plug-in node 663 switches its function pointer to a state which allows a solver to determine the optimum enabled low-power mode that may be appropriate for a processor 110 based on current conditions of the PCD 100.

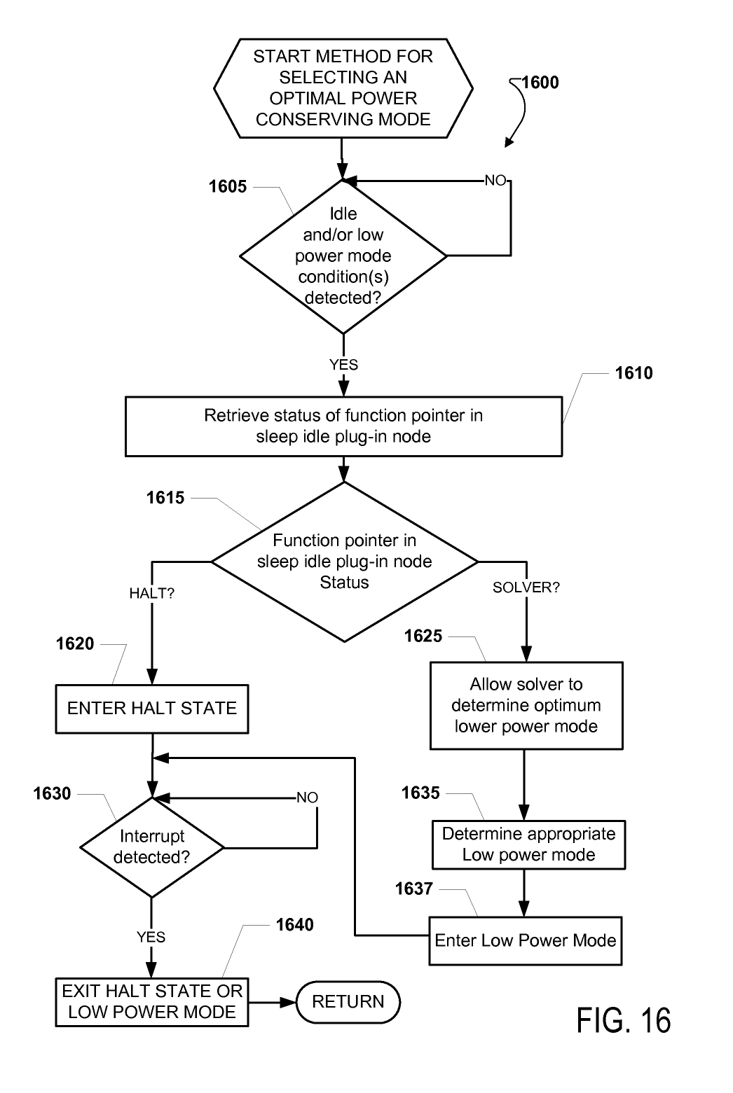

Next, in block 1545, the sleep idle plug-in node 653 caches or stores its solution which is the current state of the function pointer. The stored solution of the function pointer calculated by the sleep idle plug-in node 663 is usually accessed by the processor 110 when the processor 110 detects conditions favorable for an idle state or a halt state so that the processor 110 may conserve power. Further details about when the processor 110 accesses this function pointer will be described below in connection with FIG. 16.

FIG. 16 is a logical flowchart illustrating a method 1600 for selecting an optimal power conserving mode of a processor 110 based on the conditions tracked in the method 1500 illustrated in FIG. 15. Decision block 1605 is the first block of method 1600. In decision block 1605, idle or low-power mode conditions may be detected. Decision block 1605 may be executed by sleep code running on a processor 110. The sleep code running on the processor 110 may be part of the sleep subsystem 1490 described above in connection with FIG. 14.

If the inquiry to decision block 1605 is negative, then the “NO” branch is followed back to block 1605. The inquiry to decision block 1605 is positive, then the “YES” branch is followed to block 1610. In block 1610, the status of the function pointer cached or stored in block 1545 of FIG. 15 may be retrieved. Block 1610 may be executed or performed by sleep code running on the processor 110.

Next, in decision block 1615, the current state of the function pointer retrieved in block 1610 is determined. If the inquiry to decision block 1615 is a “HALT” state, then the “HALT” branch is followed to block 1620. In block 1620, the processor 110 enters into a halt state in which the operation of the processor 110 is stopped in order to conserve energy or power for the PCD 100.

If the inquiry to decision block 1615 is “SOLVER”, then the “SOLVER” branch is followed to block 1625 in which the solver function or feature of the sleep subsystem 1490 is permitted to solve or determine which optimum enabled low-power mode tracked by a node 664 should be entered into by the processor 110. In block 1635, the appropriate enabled low-power mode is determined by the solver. A solver, as understood by one of ordinary skill in the art, may take form of computer code that determines the most efficient low-power mode tracked by a node 664 that should be selected based on current conditions of the PCD 100. Stated differently, a solver may comprise software, which may be part of an operating system (“O/S”), that has one of its main functions to determine which of the available and enabled low-power modes should be selected based on current conditions of the portable computing device 100 as understood by one of ordinary skill in the art. In block 1637, the low-power mode selected by the solver is then entered. The process continues to decision block 1640 as described above.

Going back to block 1620, in which the processor 110 has been halted, the process continues to decision block 1630. In decision block 1630, the processor 110 determines whether or not an interrupt service request (“ISR”) has been detected. If the inquiry to decision block 1630 is negative, the “NO” branch is followed such that the processor 110 remains in its halted or low-power state. If the inquiry to decision block 1630 is positive, then the “YES” branch is followed to block 1640 in which the processor 110 exits the halted state or low-power state and performs any necessary cleanup processes as understood by one of ordinary skill in the art.

After these cleanup processes are performed, the processor 110 may resume operations such that it may service any new task or existing tasks that were put on hold before the processor 110 entered into the halted state or low-power state. The process 1600 then returns.

In view of FIGS. 14-16, it is apparent to one of ordinary skill in the art that the sleep idle plug-in node 663 gathers system constraints during run time of a processor 110 as they change in order to make a decision outside of any idle condition as to whether a processor 110 should be halted during an idle state or if the processor 110 should be placed into an enabled low-power mode. The sleep idle plug-in node 663 is invoked outside of any sleep context as resources 665 and drivers 648 are running within the processor 110.

When the sleep idle plug-in node 663 detects a condition ripe for halting or a low power mode tracked by a node 664 during run time, the sleep idle plug-in at 206 will switch a function pointer to a halt state such that the halt function will be invoked when a processor 110 determines that conditions are right for conserving power of the PCD 100. The sleep idle plug-in node 206 is tracking conditions for determining when a halt state should be entered into as requests are received and processed by a processor 110 are sent by various resources 665.

One of the major benefits of the sleep idle plug-in node 663 is that it checks for changes in conditions as they occur instead of waiting for conditions that may trigger a low-power mode or halt condition for a processor 110. Another major benefit is that sleep idle plug-in node 662 does not wait for a processor 110 to enter into a single-threaded mode in order to determine if conditions are right for either a halt state or low power state for a processor 110. The sleep idle plug-in node 662 assesses conditions while a processor 110 is not in a single threaded mode. The sleep idle plug-in node 662 receives notice of latency changes from the latency restriction tracking node 661 and the sleep LPR node 662 which tracks whether low-power modes have been enabled.

The assessments made by the sleep idle plug-in node 663 occur continuously as requests are processed by the processor 110 instead of waiting for potential idle states of the processor. The sleep idle plug-in node 663 moves sleep assessment and halt assessments to an earlier stage of processing—to when conditions of a processor 110 change, such as when latency restrictions are changed by a driver 648 instead of waiting for an idle state or conditions that may be favorable for a low-power sleep state.

So for example, in an audio example, a driver 648 wants to register a latency restriction of 2 ms. Therefore, the driver 648 would register the latency restriction with the latency restriction tracking node 661. In the conventional art, during the execution of an audio file, the assessments to determine how the change in latency to 2 ms may impact low power modes or when a halt state should be selected by the processor 110 would be executed every time the processor 110 entered into an idle state.

An idle state during playback of an audio file could occur at a rate of 1000 times a second. Now, with the sleep idle plug-in node 662, the assessment of how the change in latency to 2 ms will be evaluated outside of any idle state and usually before any idle state for the processor 110.

In view of the disclosure above, one of ordinary skill in the art is able to write computer code or identify appropriate hardware and/or other logic or circuitry to implement the distributed resource management system and method without difficulty based on the flowcharts and associated description in this specification, for example. Therefore, disclosure of a particular set of program code instructions or detailed hardware devices is not considered necessary for an adequate understanding of how to make and use the distributed resource management system and method. The inventive functionality of the claimed computer implemented processes is explained in more detail in the above description and in conjunction with the drawing figures, which may illustrate various process flows. Further, the processors 110, 126, 202, 206, etc., in combination with the memory 112 and the instructions stored therein may serve as a means for performing one or more of the method steps described herein.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage medium may be any available medium that may be accessed by a computer. By way of example, and not limitation, such computer-readable media may comprise RAM, ROM, EEPROM, CD-ROM or other optical disk storage, magnetic disk storage or other optical or magnetic storage devices, or any other medium that may be used to carry or store desired program code in the form of instructions or data structures and that may be accessed by a computer. The term “disk” or “disc,” as used herein, includes but is not limited to compact disc (“CD”), laser disc, optical disc, digital versatile disc (“DVD”), floppy disk and Blu-ray disc. Combinations of the above should also be included within the scope of computer-readable media.

Although selected aspects have been illustrated and described in detail, it will be understood that various substitutions and alterations may be made therein without departing from the spirit and scope of the present disclosure, as defined by the following claims.

What is claimed is:

1. A method for tracking and selecting optimal power conserving modes of a portable computing device (“PCD”) comprising:
detecting enablement of a low power mode;
detecting one of a new and a change in a latency restriction;
identifying a low power mode which has a minimum entry and exit latency;
determining if a lowest latency restriction is less than the minimum entry and exit latency; and
adjusting a function pointer based on the determining step.

2. The method of claim 1, wherein detecting enablement and detecting one of a new and a change in a latency restriction are performed in parallel.

3. The method of claim 1, further comprising:
determining if conditions are favorable for at least one of an idle state and a reduced power mode of the PCD.

4. The method of claim 3, further comprising:
if conditions are favorable for at least one of an idle state and a reduced power mode for the PCD, then reading a current state of the function pointer.

5. The method of claim 4, further comprising:
entering a halt state for a processor of the PCD if the function pointer references a halt state.

6. The method of claim 5, further comprising:
determining if an interrupt has been detected.

7. The method of claim 6, further comprising:
generating a message to exit the halt state if an interrupt has been detected.

8. The method of claim 4, further comprising:
determining an optimal reduced power mode for a processor of the PCD if the function pointer references a solver state.

9. The method of claim 1, wherein determining if a lowest latency restriction is less than the minimum entry and exit latency and adjusting a function pointer based on the determining step are performed by one or more nodes in a software system for managing resources of PCD.

10. The method of claim 1, further comprising determining if no low-power modes have been enabled.

11. A computer system for tracking and selecting optimal power conserving modes of a portable computing device, the system comprising:
a processor operable for:
detecting enablement of a low power mode;
detecting one of a new and a change in a latency restriction;
identifying a low power mode which has a minimum entry and exit latency;
determining if a lowest latency restriction is less than the minimum entry and exit latency; and
adjusting a function pointer based on the determining step.

12. The system of claim 11, wherein detecting enablement and detecting one of a new and a change in a latency restriction are performed in parallel.

13. The system of claim 11, wherein the processor is further operable for determining if conditions are favorable for at least one of an idle state and a reduced power mode of the PCD.

14. The system of claim 13, wherein the processor is further operable for determining if conditions are favorable for at least one of an idle state and a reduced power mode for the PCD, then reading a current state of the function pointer.

15. The system of claim 14, wherein the processor is further operable for entering a halt state for a processor of the PCD if the function pointer references a halt state.

16. The system of claim 15, wherein the processor is further operable for determining if an interrupt has been detected.

17. The system of claim 16, wherein the processor is further operable for generating a message to exit the halt state if an interrupt has been detected.

18. The system of claim 14, wherein the processor is further operable for determining an optimal reduced power mode for a processor of the PCD if the function pointer references a solver state.

19. The system of claim 11, wherein determining if a lowest latency restriction is less than the minimum entry and exit latency and adjusting a function pointer based on the determining step are performed by one or more nodes in a software system for managing resources of PCD.

20. The system of claim 11, wherein the processor is further operable for determining if no low-power modes have been enabled.

21. A computer system for tracking and selecting optimal power conserving modes of a portable computing device (“PCD”), the system comprising:
means for detecting enablement of a low power mode;
means for detecting one of a new and a change in a latency restriction;
means for identifying a low power mode which has a minimum entry and exit latency;
means for determining if a lowest latency restriction is less than the minimum entry and exit latency; and
means for adjusting a function pointer based on the determining step.

22. The system of claim 21, wherein the means for detecting enablement and the means for detecting one of a new and a change in a latency restriction operate in parallel.

23. The system of claim 21, further comprising means for determining if conditions are favorable for at least one of an idle state and a reduced power mode of the PCD.

24. The system of claim 23, further comprising means for reading a current state of the function pointer if conditions are favorable for at least one of an idle state and a reduced power mode for the PCD.

25. The system of claim 24, further comprising means for signaling a processor to enter a halt state of the PCD if the function pointer references a halt state.

26. The method of claim 25, further comprising means for determining if an interrupt has been detected.

27. The system of claim 26, further comprising means for generating a message to exit the halt state if an interrupt has been detected.

28. The system of claim 24, further comprising means for determining an optimal reduced power mode for a processor of the PCD if the function pointer references a solver state.

29. The system of claim 21, wherein the means for determining if a lowest latency restriction is less than the minimum entry and exit latency and the means for adjusting a function pointer based on the determining comprise one or more nodes executed by software of the PCD.

30. The system of claim 21, further comprising means for determining if no low-power modes have been enabled.

31. A computer program product comprising a computer usable medium having a computer readable program code embodied therein, said computer readable program code adapted to be executed to implement a method for tracking and selecting optimal power conserving modes of a portable computing device (“PCD”), said method comprising:
detecting enablement of a low power mode;
detecting one of a new and a change in a latency restriction;
identifying a low power mode which has a minimum entry and exit latency;
determining if a lowest latency restriction is less than the minimum entry and exit latency; and
adjusting a function pointer based on the determining step.

32. The computer program product of claim 31, wherein detecting enablement and detecting one of a new and a change in a latency restriction are performed in parallel.

33. The computer program product of claim 31, wherein the program code implementing the method further comprises:
determining if conditions are favorable for at least one of an idle state and a reduced power mode of the PCD.

34. The computer program product of claim 33, wherein the program code implementing the method further comprises:
reading a current state of the function pointer if conditions are favorable for at least one of an idle state and a reduced power mode for the PCD.

35. The computer program product of claim 34, wherein the program code implementing the method further comprises:
entering a halt state for a processor of the PCD if the function pointer references a halt state.

36. The computer program product of claim 35, wherein the program code implementing the method further comprises:
determining if an interrupt has been detected.

37. The computer program product of claim 36, wherein the program code implementing the method further comprises:
generating a message to exit the halt state if an interrupt has been detected.

38. The computer program product of claim 34, wherein the program code implementing the method further comprises:
determining an optimal reduced power mode for a processor of the PCD if the function pointer references a solver state.

39. The computer program product of claim 31, wherein determining if a lowest latency restriction is less than the minimum entry and exit latency and adjusting a function pointer based on the determining step are performed by one or more nodes in a software system for managing resources of PCD.

40. The computer program product of claim 31, wherein the program code implementing the method further comprises:
determining if no low-power modes have been enabled.
